(19) United States
(12) Patent Application Publication
(10) Pub. No.: US 2018/0175470 A1
(43) Pub. Date: Jun. 21, 2018

(54) LITHIUM-BROMINE RECHARGEABLE ELECTROCHEMICAL SYSTEM AND APPLICATIONS THEREOF

(71) Applicants: Peng Bai, Cambridge, MA (US); Martin Z. Bazant, Wellesley, MA (US); Venkatasubramanian Viswanathan, Cambridge, MA (US)

(72) Inventors: Peng Bai, Cambridge, MA (US); Martin Z. Bazant, Wellesley, MA (US); Venkatasubramanian Viswanathan, Cambridge, MA (US)

(21) Appl. No.: 15/820,873

(22) Filed: Nov. 22, 2017

Related U.S. Application Data
(63) Continuation of application No. PCT/US2016/034312, filed on May 26, 2016.
(60) Provisional application No. 62/185,173, filed on Jun. 26, 2015.
(60) Provisional application No. 62/166,210, filed on May 26, 2015.

(51) Int. Cl. H01M 12/08; H01M 4/38

(52) U.S. Cl. CPC H01M 12/08; H01M 2220/20; H01M 4/382

(57) ABSTRACT

The present invention is directed to the design and fabrication of a lithium-bromine rechargeable electrochemical system. The lithium-bromine fuel cell as described herein uses highly concentrated bromine catholytes of various different compositions of LiBr and Bra, representing different states of charge (SOC) associated with 11M LiBr solution by conservation of elemental bromine. The degradation of the rate-limiting component and the lithium ion conducting solid electrolyte are investigated by various characterization techniques, including scanning electron microscopy and electrochemical impedance spectroscopy. The results indicate that a properly designed rechargeable Li-Br fuel cell system can power long-range electric vehicles.

### CROSS-REFERENCE TO RELATED APPLICATION(S)

This application is a Bypass Continuation Application of International Application No. PCT/US2016/034312, entitled “A Lithium-Bromine Rechargeable Electrochemical System and Applications thereof,” filed May 26, 2016, which claims the benefit under 35 U.S.C. § 119(e) of U.S. Application No. 62/166,210, entitled “Dual Mode Lithium Bromine Battery,” filed on May 26, 2015, and U.S. Application No. 62/185,173, entitled “A Lithium-Bromine Rechargeable Fuel Cell with High Specific Energy,” filed on Jun. 26, 2015, which applications are hereby incorporated by reference herein.

### BACKGROUND

Li-ion batteries have powered the revolution in portable electronics and tools for decades, but their initial penetration into the market for electrified transportation has so far only achieved products that are very expensive and short in driving range. Lithium-air batteries are considered among the most promising technologies beyond Li-ion batteries, since the very high theoretical specific energy may reduce the unit cost down to less than US$150 per kWh, while increase the driving range of an electric vehicle to more than 550 km. However, just as that Li-ion technology experienced many problems at its advent decades ago, Li-air technology is currently facing several challenges. For nonaqueous Li-air batteries composed of lithium metal, organic electrolyte, and porous air electrode, a robust electrolyte resistant to the attack by the reduced O₂⁻ species is yet to be developed to enable highly reversible cycling. For aqueous and hybrid Li-air batteries that adopt solid-state electrolytes to protect the nonaqueous electrolyte and lithium metal anode from contamination, it is still quite challenging to improve the poor kinetics of the oxygen reduction reaction (ORR) and the oxygen evolution reaction (OER) simultaneously and economically. To circumvent this challenge, Goodenough et al. and Zhou et al. independently extended the hybrid Li-air battery to hybrid Li-redox flow batteries by flowing through liquid catholytes instead of air. The key concept of flowing electrodes is also exploited in semi-solid flow batteries, redox flow li-ion batteries, and flowable supercapacitors.

### SUMMARY

The present invention is directed to the design and fabrication of a lithium-bromine rechargeable electrochemical system. In various embodiments, the lithium-bromine fuel cell as described herein uses highly concentrated bromine catholytes of various different compositions of LiBr and Br₂, representing different states of charge (SOC), for example associated with 11M LiBr solution by conservation of elemental bromine. The degradation of the rate-limiting component and the lithium ion conducting solid electrolyte are evaluated by various characterization techniques, including scanning electron microscopy and electrochemical impedance spectroscopy. The results indicate that a properly designed rechargeable Li-Br fuel cell system can power long-range electric vehicles.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements). All documents disclosed herein are incorporated by reference in the entirety for all purposes.

FIG. 1 Schematic illustration of the Li-Br fuel cell.

FIG. 2A illustrates 5-min Galvanostatic discharging with the 1M/9M catholyte. FIG. 2B shows polarization curves of the averaged voltages versus the applied current densities. FIG. 2C shows the corresponding power output for the proposed catholytes. Note that the saturated concentration of Br₂ in 1M LiBr is around 2.2M, which is the actual catholyte passing through the cell, no liquid Br₂ was directly introduced into the cell.

FIG. 3A illustrates 5-min Galvanostatic charging with the 1M/9M catholyte. FIG. 3B shows polarization curves of the averaged voltages versus the applied current densities for the proposed catholytes.

FIG. 4 Open-circuit and the polarization voltages under ±0.5 mA cm⁻² with the corresponding voltage efficiencies for the series of catholytes.

FIG. 5 Scanning electron microscopy images revealing the morphologies of the surfaces (left) and cross sections (right) of the (a) new LATP plate, and those immersed in (b) OM/11M, (c) 1M/9M, (d) 2M/7M, (e) 3M/5M, (f) 4M/3M, (g) 5M/1M catholytes and (h) nonaqueous electrolyte for two weeks.

FIG. 6A shows impedance spectroscopy spectra of the new LATP plate. FIGS. 6B-6H show impedance spectroscopy spectra of those immersed in 0M/11M, 1M/9M, 2M/7M, 3M/5M, 4M/3M, 5M/1M catholytes, and nonaqueous electrolyte, respectively, for two weeks. FIG. 6I shows equivalent circuit model used to fit the experimental results. FIG. 6J shows the experimental setup, wherein 1—anvil of the micrometer, 2—insulating layer, 3—platinum electrode, 4—glass substrate, and 5—LATP sample. Open squares are experimental data, and the solid lines are fitting results. ρ=Z×A/l, where Z is the measured impedance, A the surface area of the sample, and 1 the thickness of the sample.

FIG. 7 Effective resistivity of grains, ρ_{g}=R_{g}×A/l, and grain boundaries, ρ_{gb}=R_{gb}×A/l, from the impedance fitting in FIGS. 6A-6H.

FIG. 8A shows schematic illustration of the rechargeable Li-Br fuel cell system during discharging mode with a Br₂ titration system to maintain the optimal concentration of bromine in the catholyte. FIG. 8B shows schematic illustration of the rechargeable Li-Br fuel cell system during regenerative mode with a Br₂ extractor to ensure a high efficiency by keeping a low bromine concentration in the catholyte.

FIG. 9 Instead of using a homogenous mixture of Br₂ and LiBr, the energy-dense Br₂-rich electrolyte can be injected near the surface of the cathode to form a co-laminar flow in the channel, so that the solid electrolyte separator will be protected from direct contact of bromine to avoid fast degradation.

FIG. 10A shows membraneless hydrogen bromine flow battery, with a first generation MHBFB with a laminar co-flow design, which achieved the record-breaking max power of 0.8 W/cm2 and 90% efficiency at 0.25 A/cm² compared to a fuel cell, this MHBFB reduces catalyst cost by 80% and stack hardware cost by 67%. FIG. 10B shows a second generation cyclable membraneless flow battery with a flow-through cathode and dispersion blocker, which achieved even better max power of 0.925W/cm², 96% efficiency at 0.2 A/cm² and the record round trip voltage efficiency of 89%.

FIG. 11 Schematic demonstration of the proposed LISICON-free hybrid-electrolyte lithium redox flow battery. Instead of using LISICON, a porous separator and a protective flow will be employed to prevent the contamination of the anode. The injected bromine will form a high-energy and high-power laminar flow near the surface of the cathode.

FIG. 12 Schematic demonstration of a flow battery using immiscible non-aqueous and aqueous co-laminar flow to avoid the crossover contamination.

FIG. 13 Schematic demonstration of a flow battery using a homogenous Br₂-rich electrolyte to form the co-laminar flow.

FIG. 14 Schematic demonstration showing the organic protective flow on the other side of the porous separator. The design of the cathode part can be either the injected co-laminar flow or the Br₂-rich homogenous flow as shown in FIG. 13.

FIG. 15A shows an exploded view of the hybrid-electrolyte fuel cell. FIG. 15B shows schematic demonstration of the dual-mode operation of the fuel cell. FIG. 15C shows composition of the theoretical and practical pack-level specific energies of lithium-bromine (Li/Br₂) energy systems, all vanadium redox flow battery (VRFB), zinc-bromine flow battery (Zn/Br₂), LiFePO₄ (LFP), zinc-air battery (Zn/O₂) and lithium-sulphur battery (Li/S).

FIGS. 16A and 16B show performance of the fuel cell with various catholytes at the flow rate of 1 ml/(min⋅cm²) where 0.1M/1M stands for 0.1M Br₂ in 1M LiBr solution. FIG. 16A shows the voltage-current relation, and FIG. 16B shows the corresponding power density.

FIG. 17 Charging performance of the fuel cell for three different catholytes at the flow rate of 1 ml/(min⋅cm²) where 0.1M/1M stands for 0.1M Br₂ in 1M LiBr solution, while 0.0M/1M means pure LiBr solution.

FIGS. 18A-18D illustrate dual-mode operations under constant voltages with DI water under 3V, DI water under 2V, sea water under 3V, and sea water under 2V, respectively, and high-power catholyte of 0.1M Br₂ in 1M LiBr aqueous solution, at the flow rate of 3 ml/(min cm²).

FIG. 19 Scanning electron microscopy images of the surfaces of (a) new LISICON plate with scratches made by sand paper, (b) higher magnification of the new LISICON plate showing nano-sized shallow cavities, (c) Br₂/LiBr catholyte-side of the aged LISICON plate, and (d) LiPF₆/EC/DMC electrolyte-side of the aged LISICON plate.

FIG. 20 Scanning electron microscopy images of the cross-sections of (a-d) new and (e-h) aged LISICON plates; compared with the images of the new plate, a 20-μm-thick porous layer was developed into the surfaces of the aged plate, and nanopores can be observed throughout the thickness.

FIGS. 21A and 21B show schematics of the cell design for the low power and high power mode, respectively. The cell includes lithium metal at the anode protected by LiPON interlayer and LISICON separator. The protection layer ensures conduction of Li⁺ and blocks the flow of electrons and other reactants. The cathode reaction in the low power mode is the reduction of dissolved oxygen, while in the high power mode is the reduction of bromine to bromide ions.

FIG. 22 The practical system-level specific energy of several battery couples and their theoretical specific energy based on the weight of active materials alone. The DOE pack goal for an EV with a 40 kWh battery pack is shown, as well as the approximate theoretical energy, set at 4 times the DOE pack goal, required for a couple to have a chance of meeting the pack goal.

FIG. 23 Schematics of the cell design in FIGS. 21A and 21B with organic electrolyte. The cell includes lithium metal, organic electrolyte, and LISICON separator.

FIG. 24 Photograph of an experimental setup.

FIG. 25A shows dual-mode operations at low power mode and high power mode represented by a plot of current density versus time. FIG. 25B shows the open circuit voltage as a function of time.

### DETAILED DESCRIPTION

Lithium-air batteries have been considered as ultimate solutions for the power source of long-range electrified transportation, but state-of-the-art prototypes still suffer from short cycle life, low efficiency and poor power output. Here, a lithium-bromine rechargeable fuel cell using highly concentrated bromine catholytes is demonstrated with comparable specific energy, improved power density, and higher efficiency. The cell is similar in structure to a hybrid-electrolyte Li-air battery, where a lithium metal anode in nonaqueous electrolyte is separated from aqueous bromine catholytes by a lithium-ion conducting ceramic plate. The cell with a flat graphite electrode can discharge at a peak power density around 9 mW cm⁻² and in principle could provide a specific energy of 791.8 Wh kg⁻¹, superior to most existing cathode materials and catholytes. It can also run in regenerative mode to recover the lithium metal anode and free bromine with 80-90% voltage efficiency, without any catalysts. Degradation of the solid electrolyte and the evaporation of bromine during deep charging are challenges that should be addressed in improved designs to fully exploit the high specific energy of liquid bromine. The proposed system offers a potential power source for long-range electric vehicles, beyond current Li-ion batteries yet close to envisioned Li-air batteries.

One of the most attractive features of flow batteries is the decoupling of power and energy, which enables more flexible system customization, either by increasing the number of electrode pairs for higher power output, or by increasing the size of the tank and concentration of electrolytes to store more energy. For electric vehicles with limited on-board space to store electrolytes, high solubility of the active species becomes especially important. Recognizing that iodine has an extremely high solubility in iodide solutions, Byon et al. investigated the performance of dilute iodine/iodide catholyte in hybrid-electrolyte lithium batteries both in the static mode and the flow-through mode, in which the end-of-discharge product is LiI. Concentrated iodine/iodide solution was also employed in a recent zinc-polyiodide flow battery, producing ZnI₂ at the end of discharge. Comparing these two reports, although LiI and ZnI₂ solutions have similar capacity at their solubility limits, the use of a lithium anode increases the voltage almost three-fold, thus providing much higher specific energy. Table 1 summaries the theoretical specific energies of catholytes used in several state-of-the-art flow or static-liquid batteries, where LiBr solution emerges as the best candidate, having almost twice the specific energy of the aqueous Li-air battery using alkaline catholyte (LiOH).

TABLE 1
Comparison of the specific energies of various fully discharged catholytes at their
solubility limits.

| | Solubility | | Specific | | | Specific |
|---|---|---|---|---|---|---|
| | [21, 22] | Molality | capacity | | | energy |
| | [g per 100 ml | [mol kg⁻¹ | [Ah kg⁻¹ | OCV | | [Wh kg⁻¹ |
| Discharge product | of water] | of water] | of solution] | [V] | | of solution] |
| LiBr | 164.00 | 18.89 | 191.72 | 4.13 | [23] | 791.82 |
| Lil | 165.00 | 12.33 | 124.68 | 3.57 | [18] | 445.12 |
| LiOH | 12.40 | 5.18 | 123.45 | 3.4 | [2] | 419.73 |
| ZnBr₂ | 447.00 | 19.85 | 194.51 | 1.85 | [24] | 359.84 |
| Znl₂ | 332.00 | 10.40 | 129.06 | 1.30 | [20] | 167.77 |
| FeCl₂ | 62.50 | 4.93 | 81.33 | 4.06 | [11] | 330.19 |
| K₄Fe(CN)₆ · 3H₂O | 28.00 | 0.66 | 13.88 | 3.99 | [10] | 55.38 |

| | | | | | |
|---|---|---|---|---|---|
| Li₂Sₙ | — | — | — | — | 170 [25] |

This extraordinary property has started to attract the attention of researchers to develop various Li-Br batteries. Such systems always involve a liquid-solid-liquid hybrid electrolyte, in order to accommodate the nonaqueous and aqueous electrolytes. During discharge, lithium metal in the nonaqueous electrolyte is oxidized into lithium ions (Li→Li⁺+e⁻), which migrate toward the cathode, while electrons travel through the external circuit to reach the cathode. At the surface of cathode, bromine is reduced by the incoming electrons to bromide ions (Br₂+2e⁻→2Br⁻), followed by fast complexation with bromine to form more stable tribromide ions (Br⁻+Br₂↔Br₃⁻). The reactions are reversed during recharging. Zhao et al. fabricated a static Li-Br battery starting with 1M KBr and 0.3M LiBr solution, which was charged to 4.35V then discharged at various electrochemical conditions. The maximum power it could deliver within the safety window was 1000 W kg⁻¹, equivalent to 5.5 mW cm⁻² if calculated with their loading density of LiBr (5.5 mg cm⁻²). Chang et al. paired a protected lithium metal anode with a small glassy carbon electrode (3 mm diameter) to test the performance of 0.1M Br₂ in 1M LiBr and 1M Br₂ in 7M LiBr solutions, respectively. The latter provided a peak power density of 29.67 mW cm⁻² at ˜2.5V. In the development of a better Li-Br battery, Takemoto and Yamada found that degradation of LATP plate is the major source of deterioration of the cell performance. Their careful analyses on samples soaked in dilute bromine/bromide solutions for 3 days suggested the development of a Li-ion depletion layer in LATP.

Given the strongly fuming and oxidative nature of bromine, it is understandable that previous work has only considered dilute electrolytes. Indeed, the high vapor pressure of bromine that builds up in a closed static liquid cell can easily rupture the LATP separator. Such problems can be avoided in a flow cell, but a practical way of utilizing the high specific energy of lithium-bromine chemistry has yet to be proposed and demonstrated, using highly concentrated bromine/bromide catholytes.

A lithium-bromine fuel cell is designed and fabricated as described herein. The fuel cell uses highly concentrated bromine catholytes of six different compositions of LiBr and Bra, representing different states of charge (SOC) associated with 11M LiBr solution by conservation of elemental bromine. The degradation of the rate-limiting component, the lithium ion conducting solid electrolyte is investigated by various characterization techniques, including scanning electron microscopy and electrochemical impedance spectroscopy. The results indicate that a properly designed rechargeable Li-Br fuel cell system can power long-range electric vehicles.

Instead of integrating all functions into a closed system like lithium ion batteries, fuel cells and flow batteries differentiate functions into specialty modules. The cell itself is solely for electrochemical reactions and the tank for energy storage, similar to gasoline-powered vehicles, in which the internal combustion engine is solely for chemical reactions and the tank for fuel storage. In addition, a circulating aqueous electrolyte can serve as a coolant, thus enabling easier thermal management of the fuel cell by adjusting the temperature of the tank.

All components of the fuel cell were fabricated using traditional CNC machining or die cutting. A piece of copper plate was used as the current collector, and a piece of lithium metal chip as anode. To accommodate the organic electrolyte between the lithium metal and the LATP plate, a rectangular through hole was machined in a polyvinylidene fluoride (PVDF) plate, which also serves as the supporting plate to anchor four bolts for assembling components of either side of the LATP plate. A small piece of LATP plate was cut off by a diamond scriber, and bound to one side of the supporting PVDF plate by a thin layer of epoxy, and cured for at least 24 hours. The anode part was then assembled accordingly in an Ar-filled glove box, and sealed by a silicone O-ring between the copper current collector and the supporting PVDF plate. The organic electrolyte was injected into the anode chamber by a syringe. The cathode part was assembled in ambient environment. The flow channel of the catholyte was defined by a compressible Teflon gasket, whose thickness reduces to 300 μm after final assembly. A 6-mm-thick graphite plate was machined accordingly as the cathode, whose surface was simply polished with a sand paper. Another piece of gasket was placed between the graphite and the porting plate. The areas of the cross sections of the anode chamber and the flow channel are approximately the same 0.64 cm2.

For, materials, all the chemicals are used as received. Bromine (ACS Reagent, >99.5%), lithium bromide (ACS Reagent, >99.5%) and the organic electrolyte (1 M LiPF₆ in ethylene carbonate/dimethyl carbonate with a volume ratio of 1:1) are purchased from Sigma-Aldrich. The solid electrolyte plate (AG-01, Li₂O-Al₂O₃-SiO₂-P₂O₅-TiO₂-GeO₂, 10-4 S/cm, 25.4mm square by 150 μm) is purchased from Ohara Inc, Japan. Copper foil (3 mm thick, 99.5%), polyvinylidene fluoride (PVDF) plates, graphite plates, silicone o-rings and Teflon gasket tape (Gore) are all purchased from McMaster-Carr. PTFE tubing and fittings and peristaltic pumps were purchased from Cole-Parmer. Ultrapure deionized water is obtained from a water purification system (Model No. 50129872, Thermo Scientific).

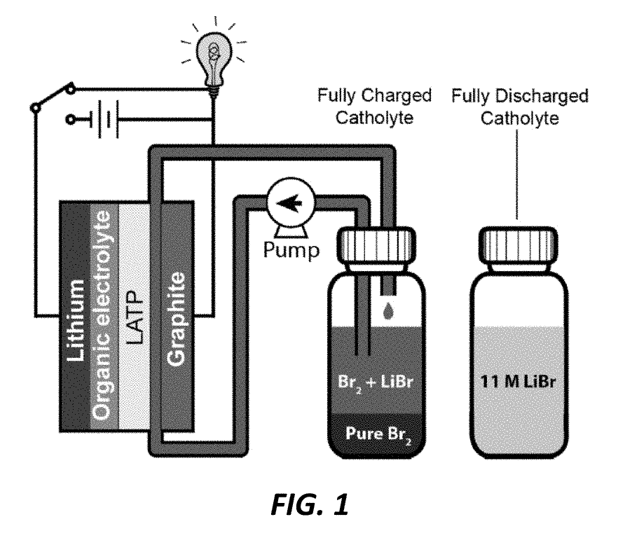

For the fuel cell design and fabrication, the structure of the fuel cell is schematically shown in FIG. 1, which is similar to the hybrid aqueous Li-air battery, where lithium metal in nonaqueous electrolyte is separated from aqueous catholytes by a solid electrolyte (Li₂O-Al₂O₃-SiO₂-TiO₂-GeO₂-P₂O₅, LATP, 10⁻⁴ S 25.4-mm square by 150-μm thick, Ohara Inc. Japan). A catalyst-free flat graphite plate is used as cathode. Catholytes flow through the cathode channel to complete the liquid-solid-liquid ionic pathway between lithium metal anode and graphite cathode. Details of the materials, design and fabrication of the fuel cell can be found elsewhere.

For catholytes preparation, theoretically, the fully discharged catholyte may not contain any Br₂ for further reduction reaction. It therefore can be pure LiBr solution. To avoid unexpected precipitation due to temperature fluctuations, the saturated LiBr solution (close to 12M) is used, and can also use the slightly more dilute option, 11M LiBr aqueous solution, as the end-of-discharge catholyte. And according to the conservation of elemental bromine, 1M Br₂ in 9M LiBr (1M/9M), 2M/7M, 3M/5M, 4M/3M and 5M/1M solutions as the intermediate catholytes are prepared. Note that only 5M/1M solution has precipitated liquid Br₂ at the bottom of the solution, since the saturated concentration of Br₂ in 1M LiBr solution is around 2.2 M (1.93 g Br₂ in 10 ml LiBr solution). Only the supernatant solution, i.e., ˜2.2M/1M, is used in the tests, but nonetheless the notation of 5M/1M is kept for easier understanding of its relation with other catholytes.

For electrochemical measurements, polarization curves are obtained using an Arbin battery tester (BT-2043, Arbin Instruments) at the flow rate of 1 ml min⁻¹ cm⁻². Every data point came from the averaged voltage of five-minute charge or discharge. Before testing a different catholyte, DI water and air were pumped to flush the tubing and cell at 5 ml min⁻¹ cm⁻² for 30 mins and 10 minutes, respectively. Potentiostatic EIS experiments of the Pt|LATP|Pt dry cells were conducted with Gamry Reference 3000, with a 5 mV excitation from 0.1 Hz to 1 MHz.

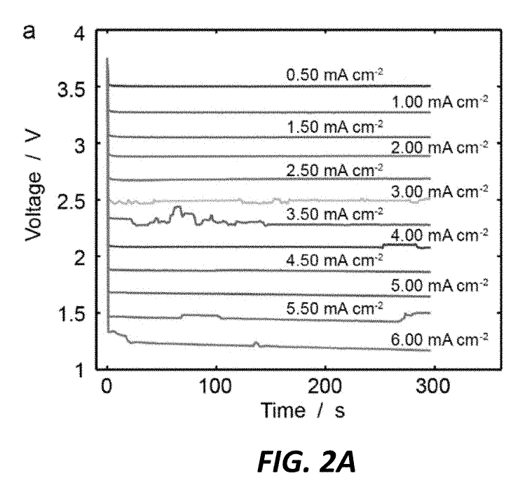

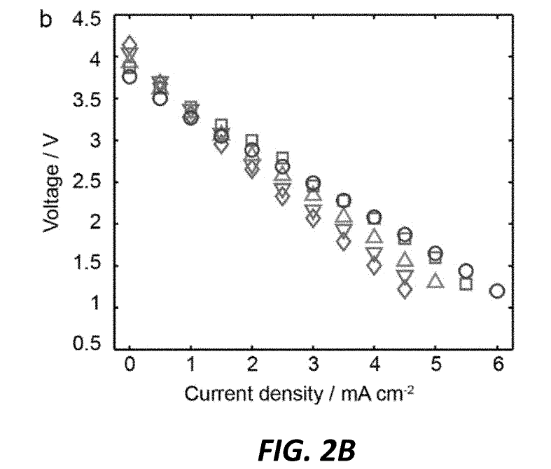

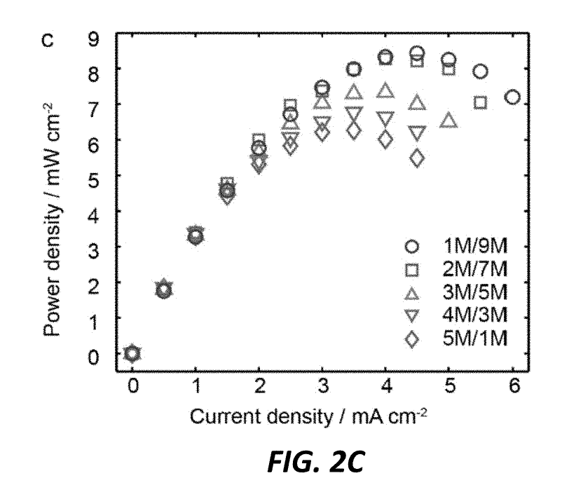

Electrochemical performance is evaluated as described herein. The polarization curves shown in FIGS. 2a-2c reveal the linear relationship between the response voltages and the applied current densities. A peak power density of 8.5 mW cm⁻² at 1.8V can be obtained with 1M Br₂ in 9M LiBr (1M/9M) solution, which is consistent with the recent reports of both the static [23] and flow [30] Li-Br cells using dilute bromine catholytes. The fact that increasing the concentration of Br₂ here does not improve the discharge performance further confirms that the rate-limiting process is not transport in the liquid catholyte, but the conduction of lithium ions through the ceramic solid electrolyte. Data in FIGS. 2a-2c also reveal that the slope of the polarization curves becomes increasingly steeper and power density smaller over time. This is due to the cumulative corrosion of the LATP electrolyte plate, consistent with the sequence of experiments from low Br₂ concentration to high Br₂ concentration.

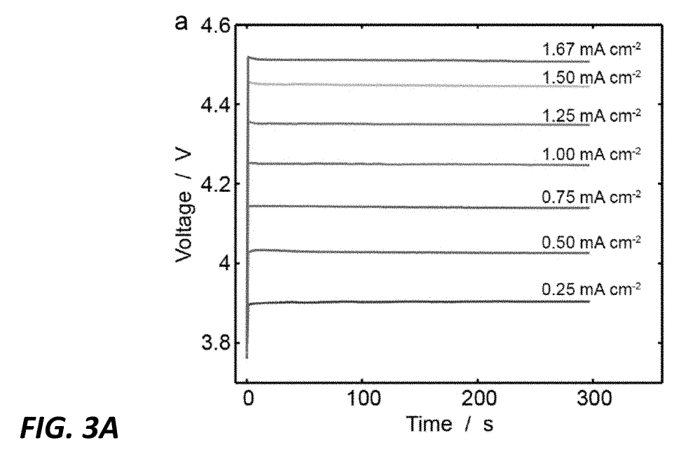

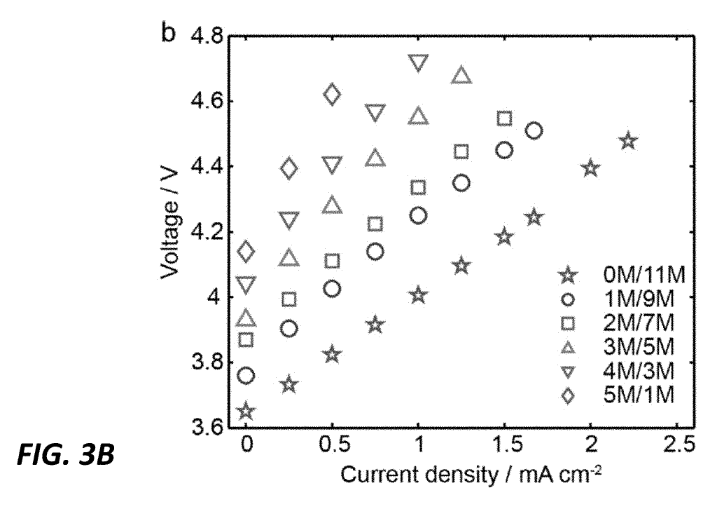

FIGS. 3a and 3b show polarization data for the charging processes with the proposed bromine/bromide catholytes and the 11M LiBr solution without any Br₂ (0M/11M). Again, the slight increase of the slope reflects the cumulative deterioration of the LATP plate, consistent with the sequence of the experiments. At a given current density, the charging overpotential increases with the increase of bromine concentration. Note that for the 5M/1M solution, the saturated concentration of bromine in 1M LiBr is around 2.2M, similar to 2M/7M solution, which is expected to yield similar performance. However, since the latter has a much higher concentration of the supporting salt LiBr, it results in a much lower overpotential than for the 5M/1M solution.

Limited by the solid electrolyte, the maximum current density that can be obtained is too low to complete a charge-discharge cycle before the breakdown of the solid electrolyte plate due to corrosion, or the exhaust of the electrolyte due to leakage, since even only 10 ml highly concentrated catholyte requires hundreds of days to be converted electrochemically. Here, to evaluate the efficiency, another figure of merit widely used in the field of flow batteries is chosen to show the voltage efficiency, defined as the ratio of the discharging voltage and the charging voltage at a given current density.

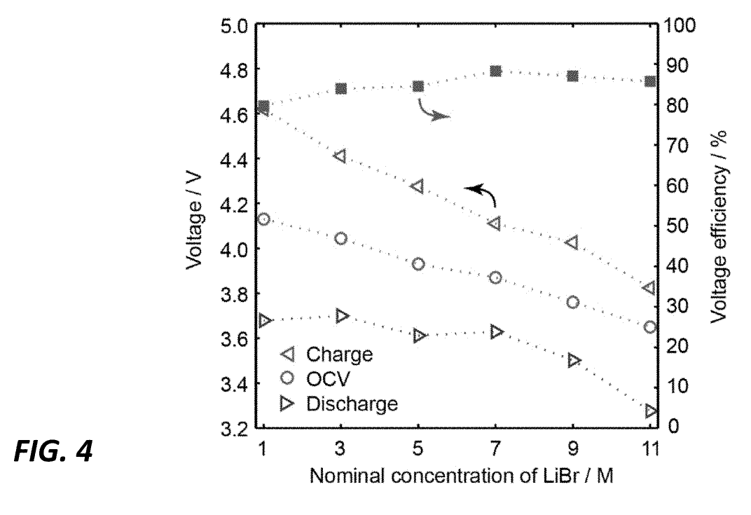

The voltage efficiencies at ±0.5 mA cm⁻² shown in FIG. 4 are in the range of 80%-90%, which reflect relatively small voltage hysteresis (0.67V in average), better than typical Li-air batteries at lower currents. Due to the sluggish kinetics of ORR and OER, the voltage hysteresis of nonaqueous Li-air batteries using carbon electrode is typically larger than 1V even for currents as small as 0.105mA cm⁻². Cells with gold-modified electrodes and novel electrolytes containing redox mediators can exhibit 1V hysteresis at a slightly higher current density 0.313 mA cm⁻². The hysteresis only becomes comparable with TiC electrodes and electrolyte of 0.5M LiPF₆ in tetraethyleneglycol dimethylether (TEGDME). Reaction kinetics in aqueous Li-air batteries are even worse, due to the higher activation energy for cleavage of the O—O bond, but the hysteresis can be reduced to 0.75V by increasing the operation temperature to 60° C. In general, Li-air batteries do not allow high power operation since the insulating discharge product would shut down the battery due to conformal coating to the air electrode.

In contrast, the Li-Br fuel cell does not have this problem due to the extraordinary solubility of its discharge product LiBr (˜12 mole per liter of solution, or 18.89 mole per kg of water). Yet the open design allows operation outside the electrochemical stability window to achieve higher power output, since the generated gas can be brought out of the cell with the flowing stream, instead of building up inside the cell to rupture the LATP separator. While the fairly rapid degradation of LATP in concentrated bromine catholytes precludes the demonstration of reversible cycling with concentrated bromine catholytes, superior Coulombic efficiencies have been achieved in other aqueous lithium flow batteries using dilute I₂/LiI solution and dilute K₄Fe(CN)₆ solution.

In some embodiments, the degradation of the solid electrolyte can be an issue. The deterioration of LATP has been intensely investigated for applications to aqueous Li-air batteries with various solutions, including water, acidic solutions, and basic solutions. In a recent work, Takemoto and Yamada investigated the surface structure of the aged LATP samples by grazing incident X-ray diffraction (GIXD) and attenuated total reflection Fourier transform infrared spectroscopy (ATR-FT-IR). However, phase impurities and chemical changes that had been observed in samples immersed in strong acidic solutions were not found in their samples immersed in bromine-bromide catholytes containing 1M elemental Br, even though Br₂ disproportionates in water to form several species including acidic HBrO and HBrO₃. The degradation was attributed then to the only remaining conjecture of a Li⁺-depletion layer developed into the surface of LATP plate. Small pieces of LATP samples are immersed in the proposed concentrated catholytes (containing 11M elemental Br) as well as the nonaqueous electrolyte for two weeks, and then characterized them with scanning electron microscopy (SEM) and electrochemical impedance spectroscopy (EIS).

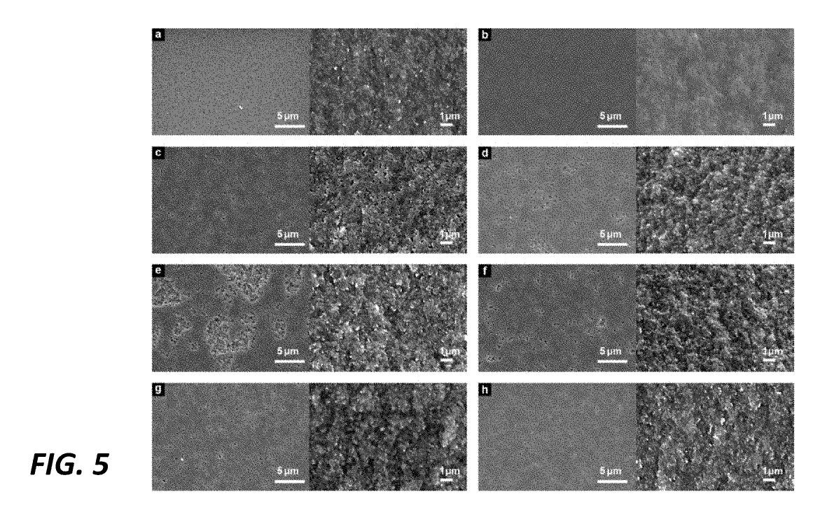

SEM images of the aged LATP plates are shown in FIGS. 5a-5h. The glassy surface of the new LATP plate is difficult to focus in SEM, as the fine and shallow cavities cannot produce as strong contrast as the aged plates, in which both the size and depth of the cavities are clearly increased after immersion in different solutions. What was not discovered before is that the surface, although it still looks flat, develops roughness and asperities that can become loose. In fact, chunks of material are observed to be blown off (e.g. FIG. 5e) in the flow of the catholytes, which indicates that there existed significant corrosion well below the deep cavities observed on the surface. Focusing on the middle part of their cross sections, typically in the region 70 μm away from either surface, i.e., the least-corroded part of the solid electrolyte can be observed. It is clear to see that the cross sections of the new plate and the one immersed in 11M LiBr solution look dense and uniform with continuous and smooth connections among grains. However, nanopores between grains can be easily identified in the sample immersed in 1M/9M solution. With increased concentration of bromine, the cross sections of the samples look much more rough and porous. Individual grains with little contact to their surroundings reveal the severe corrosion of the grain boundaries. The SEM images of the sample immersed in nonaqueous electrolyte also show deep cavities on the surface and rough and porous morphology in the bulk, consistent with earlier reports. These structural degradations are well associated with the deterioration of the conductivity of the solid electrolyte, which can be evaluated quantitatively by electrochemical impedance spectroscopy.

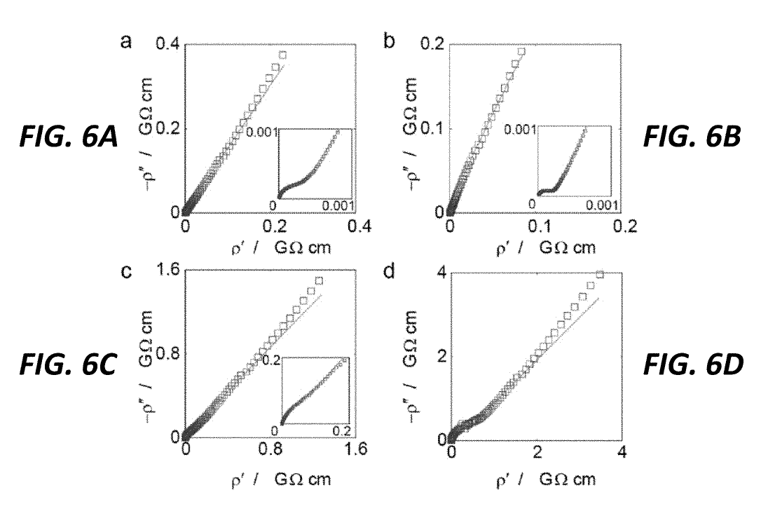

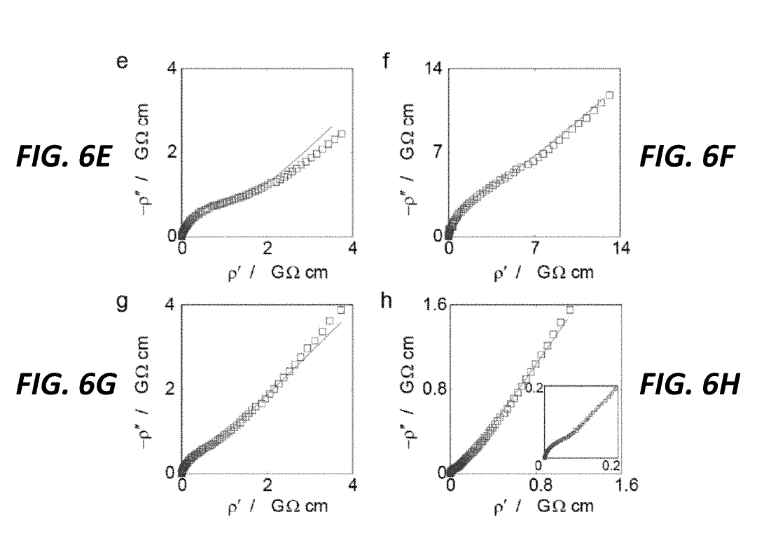

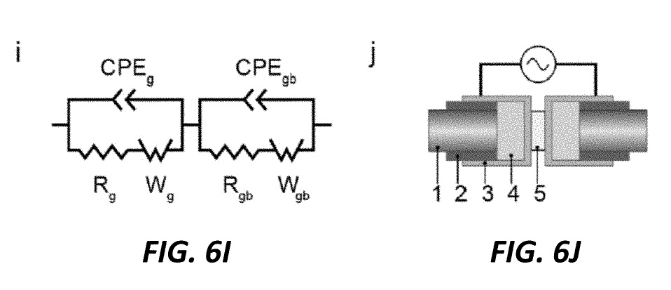

To obtain the EIS spectra for all eight samples, shown in FIGS. 6a-6h, two pieces of platinum foil were attached to the anvils of a micrometer, which was used to hold the sample and form a Pt|LATP|Pt dry cell, shown as the equivalent circuit in FIG. 6i and the experimental setup in FIG. 6j. This simple design avoids short circuiting at edges of the small LATP samples created by sputtering gold electrode onto both surfaces. While it may not guarantee accurate measurements of the absolute conductivity of the LATP samples, due to less intimate contact than sputtered gold electrode, it is adequate for us to investigate the relative increase of the impedance of the aged LATP samples and compare them with the new LATP sample. Consistent with the SEM observation, the new LATP plate and the one soaked in 11M LiBr solution exhibit similar impedance behavior, but the latter forms a much clearer and smaller semicircle at high frequencies, indicating improved conductivity. In general, the impedance of the aged LATP plates increases with the increase of bromine concentration in the solutions. Note that for 5M/1M solution, the saturated concentration of bromine is around 2.2M, and its impedance spectra coincide with that of 2M/7M solution.

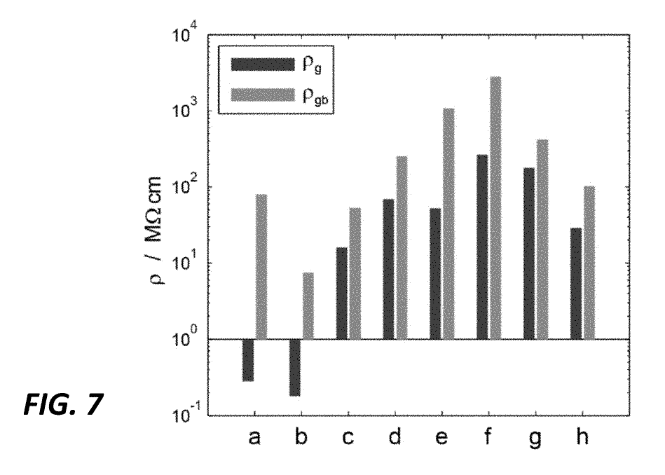

Various equivalent circuit models have been proposed to fit the impedance of ceramic solid electrolytes. As shown in FIG. 6i, the impedance can be attributed to two parts, one to the grains and the other to the grain boundaries. FIG. 7 shows the fitted resistances of grains and grain boundaries corresponding to the results displayed in FIG. 6. Both the grain and grain-boundary resistance of the sample soaked in 11M LiBr are lower than the new plate, which coincide with the smooth cross section shown in FIG. 5b. The resistances of other samples have a clear trend with respect to the concentration of dissolved bromine. The one soaked in nonaqueous battery electrolyte shows increased resistance similar to that soaked in 1M/9M solution, although the cross-section morphologies look quite different.

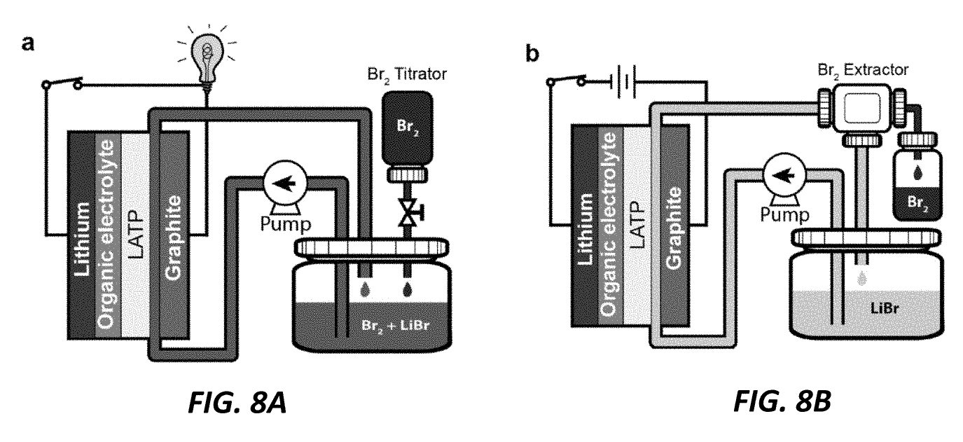

The strong corrosion effects of bromine solution jeopardize the durability of the fuel cell. This difficulty led us to the system design shown in FIG. 8a. The fuel cell system could involve a primary fuel tank storing pure bromine, which can be released through an electronic valve into a secondary tank to maintain the optimal concentration of the catholyte that will be circulated through the fuel cell until the full tank of bromine is exhausted and completely converted to LiBr solution. For systems using currently available water-stable solid electrolytes, one may consider only using dilute bromine (but not necessarily dilute LiBr) catholytes, which could provide similar peak power and better Coulombic efficiency and longer life as shown in previous work. Apparently, the combination of the flow cell and the Br₂ tank is the only way to exploit the high specific energy of lithium-bromine chemistry, since the lack of a strong and corrosion-resistant solid electrolyte implies that static Li-Br batteries will only work with limited amount of dilute bromine catholytes, whose specific energy (˜100 Wh (kg-catholyte)⁻¹) is not superior to existing Li-ion batteries (˜500 Wh (kg-cathode)⁻¹), and cycle life not longer than Li-redox flow batteries using less corrosive catholytes.

While discharging with Br₂ catholyte is straightforward, the key to achieve the proposed theoretical specific energy and a high Coulombic efficiency relies on whether all the lithium ions and bromide ions generated during discharge can be recovered to metallic lithium and free bromine, respectively. The constant-voltage charging with saturated Br₂ in 1M LiBr solution, i.e., the supernatant solution in the 5M/1M catholyte is performed for 46 hours. The total charged capacity was 1.9 mAh, which should convert to 1 mL of liquid Br₂. However, the color of the catholyte at the end of the 46-hour charging is much lighter and does not fume as much as the initial catholyte, which indicates the loss of bromine by evaporation. Installing a Br₂ extractor, as shown in FIG. 8b, which can be as simple as an air blower plus a condenser, to separate the free bromine from the recharging stream may help reduce the energy loss by evaporation, and also alleviate the corrosion of LATP plate by keeping a low bromine concentration.

As demonstrated above, the highly concentrated 11M LiBr solution is both the most efficient catholyte for charging and the least corrosive catholyte to the LATP plate. Therefore, using 11M LiBr solution as a standard charging catholyte and modularizing the 11M-LiBr tank with the bromine extractor off-board, while only keeping the discharging module on-board, may become a highly efficient mode of operation for electric vehicles. The off-board charging system could also be enlarged as a recharging/refueling station, where the recharging stream can be guided to and processed with more sophisticated extractors, and the extracted bromine refueled into the on-board tank. The situation is analogous to capturing the exhaust of a combustion engine and exchanging it for a fresh tank of gasoline at the station—with the important difference that exhaust product (11M LiBr solution to be returned) is efficiently converted back into chemical fuels (liquid Br₂ and Li metal to be picked up) at the station, using only electricity without directly consuming any chemicals. Since the electricity could come from a renewable resource (solar or wind) at the refueling station, this concept could provide a means of sustainable power for electrified transportation.

Just as with all other lithium metal batteries, dendritic electrodeposition of lithium during recharging is a serious safety concern and lifetime challenge. Using solid electrolytes is believed to be an effective method to block lithium dendrite from shorting the cell, but the water-stable LATP is unstable in contact with lithium metal, which is a reason for the nonaqueous buffer layer employed in the design. Developing composite solid electrolytes that provide dual stability against lithium metal and water addresses this problem. Directly stabilizing the lithium metal anode during high-rate cycling can also be helpful. Although not yet investigated in deep-recharging situations, recent advances suggested many promising technologies, including creating protection layer of carbon semispheres to isolate lithium deposition, using extremely highly concentrated organic electrolyte to retard the concentration instability at metal surfaces, adding halogen ions or metal ions to modulate the reactions, and modifying the surface charge of the separator to trigger stable “shock electrodeposition”.

By exploiting the fast kinetics of aqueous bromine/bromide catholytes, the Li-Br fuel cell exhibits much better power density than state-of-the-art Li-air batteries, which usually discharge well below 3 mW cm⁻² even with catalyzed electrodes and modified electrolytes. To achieve power densities comparable to proton exchange membrane (PEM) fuel cells already installed in electric vehicles, however, a thinner solid electrolyte with higher ionic conductivity, supported by strong substrates, may be suitable. Another approach could be to remove the rate-limiting solid electrolyte to fabricate a membraneless system, whose power density could be increased by orders of magnitude, as the ionic conductivities of the liquid electrolytes are at least two orders of magnitude higher than that of typical solid electrolytes.

The design and fabrication of a rechargeable lithium-bromine fuel cell has been demonstrated and the feasibility of using highly concentrated bromine catholytes in order to exploit the very high specific energy of lithium-bromine chemistry has been investigated. The results reveal that the commercially available water-stable solid electrolyte LATP degrades quickly in the concentrated bromine catholytes, making long-time operation and cycling almost prohibitive. However, a new system design, which combines the fuel cell with a primary tank of pure liquid bromine and a secondary tank for dilute bromine/bromide catholytes may provide improved energy density closer to the theoretical high energy density. While static Li-Br batteries are only able to work with limited amount of dilute catholytes, yielding less appealing performance in specific energy and cycle life than existing technologies, the present Li-Br system is a viable technology to provide sustainable power for long-range electric vehicles, as research continues toward higher-power and more robust Li-air batteries.

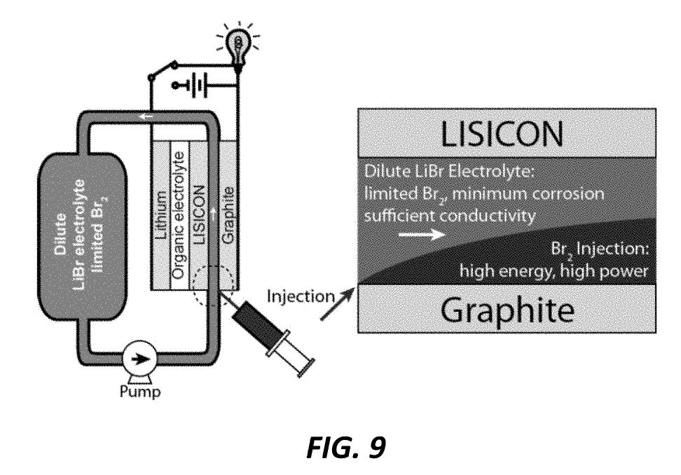

As described earlier, protection of the solid electrolyte, such as LISICON or LATP is important in a functioning fuel cell. As discovered from the experiments, the degradation of LATP was mainly induced by the bromine corrosion. Using a co-laminar flow of LiBr electrolyte near the LATP and Br2 only near the cathode, may protect the LATP from fast corrosion of bromine, as shown in FIG. 9.

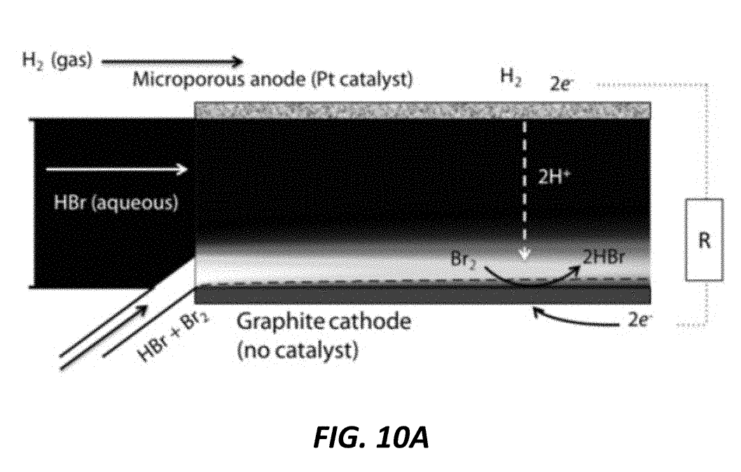

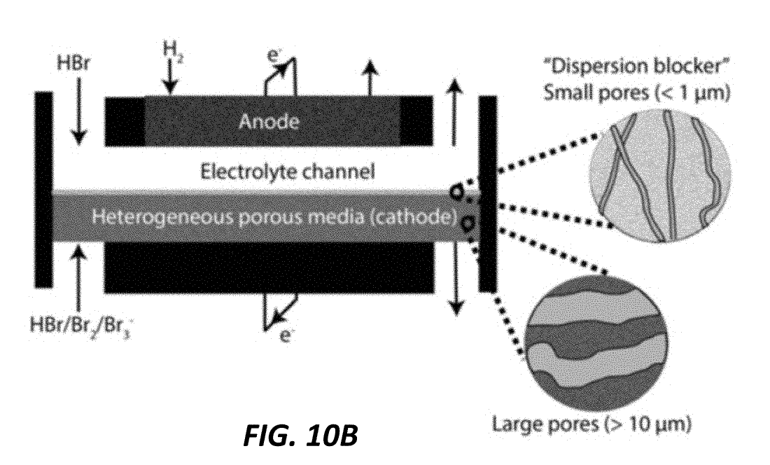

In some embodiments, a membraneless hybrid-electrolyte lithium-bromine rechargeable fuel cell can be designed and fabricated to overcome the above corrosion problem. The novel membraneless hydrogen bromine flow batteries (MHBFB) as shown in FIGS. 10a and 10b can achieve a record-breaking performance in terms of the power density (0.92 W/cm²), Coulombic efficiency (97%), voltage efficiency (90%), and ultralow cost ($5/kWh, 67$/kW), with a reasonable closed-loop cycle life (˜100 cycles), which can be extended by occasionally purifying the electrolyte stream of the (very minor) bromine crossover. In particular, a membraneless hydrogen bromine flow battery with a first generation MHBFB, as shown in FIG. 10a with a laminar co-flow design, which achieved the record-breaking max power of 0.8 W/cm2 and 90% efficiency at 0.25 A/cm² compared to a fuel cell, this MHBFB reduces catalyst cost by 80% and stack hardware cost by 67%. FIG. 10b shows a second generation cyclable membraneless flow battery with a flow-through cathode and dispersion blocker, which achieved even better max power of 0.925 W/cm², 96% efficiency at 0.2 A/cm² and the record round trip voltage efficiency of 89%.

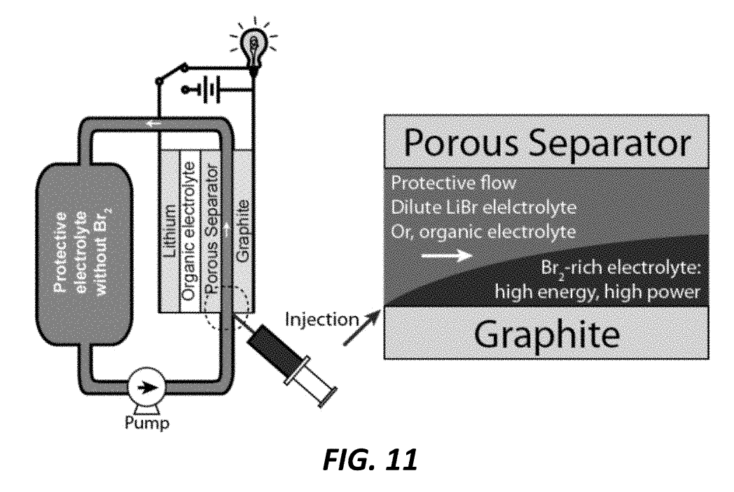

The successfully realized idea of replacing the most expensive component of the H-Br flow battery, the Nafion membrane, with laminar flows can also be applied to the lithium-bromine system. A key difference is that, in the place of the LISICON film, the flow is used to prevent not only the crossover of ionic species, but also the mixing of the organic solvents and the water, as demonstrated in FIG. 11.

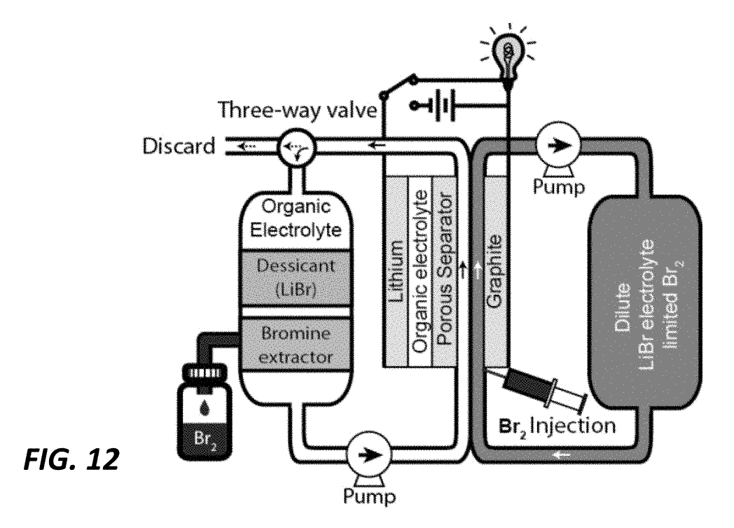

Given that non-aqueous (organic) solvents usually have a very low solubility in water, another possible approach is to use a co-laminar flow of immiscible non-aqueous and aqueous electrolytes, shown in FIG. 12. The protective non-aqueous electrolyte can be dehydrated and purified (or discard) and then recirculated into the cell. Since the protective aqueous flow only has limited amount of Bra, a Bra-rich electrolyte can be injected into the aqueous stream, near the cathode surface to boost the power output.

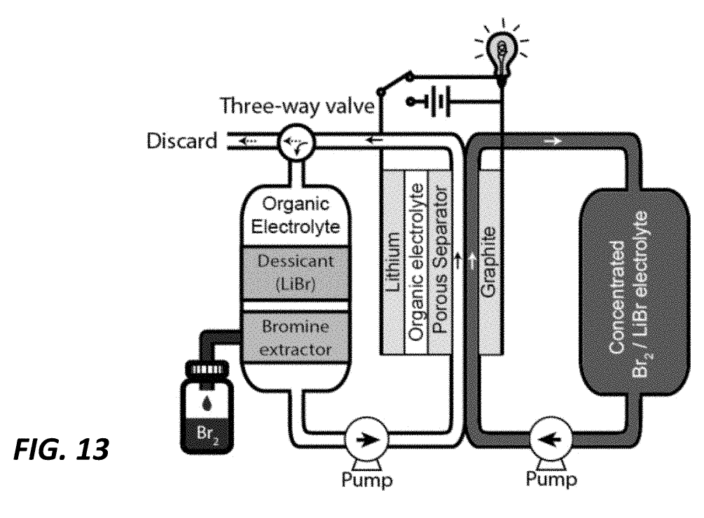

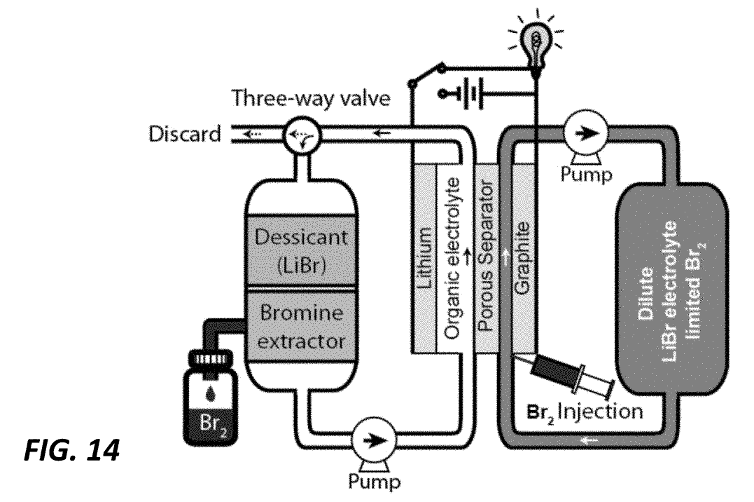

As another embodiment, FIG. 13 demonstrates the possibility of using homogenous Bra-rich electrolyte to form the co-laminar flow. In addition, the protective organic (non-aqueous) flow can be constructed on the other side of the porous separator, depicted as another embodiment, as shown in FIG. 14.

In some embodiments, a fuel cell or flow battery can include a metal anode, a solid or liquid anolyte, a liquid catholyte, a liquid redox cathode and a current collector. In some embodiments, an oxidant can be recovered from the cathode waste stream by non-electrochemical methods and injected back into the catholyte, which is pumped in only one direction over the cathode. In some embodiments, an anode or membrane can be protected via the use of liquid anolyte compatible with metal anode, solid membrane separator, one or more different liquid catholytes. In some embodiments, for membraneless architecture without the ion-selective membrane, laminar flow membraneless battery with metal anode and different liquid catholyte and anolyte can be constructed.

In some embodiments, suitable anolytes include water-stable zero-porosity metal ion conducting solid electrolyte membranes such as LIPON, LISICON, LATP, NaSICON, etc. Alternatively, the anolyte is a pure or mixed aprotic solvent comprising one or more of EC, PC, DEC, DMC, DME, DOL, etc., with metal salt separated from catholyte by a solid electrolyte membrane (e.g., LATP manufactured by Ohara). In other embodiments, the anolyte comprises room temperature ionic liquids or RTIL/solvent mixtures, as described in “A new class of solvent-in-salt electrolyte for high-energy rechargeable metallic lithium batteries,” Nature communications, 4, 1481, by Suo, Hu, Li, Armand, and Chen.

In some embodiments, suitable catholytes include aqueous solutions containing O₂, Br₂, I₂, FeCl₃, K₃Fe(CN)₆, poly sulfides, etc. In some embodiments, the cathode can “flow over” graphite. In some embodiments, the cathode can “flow through” a porous carbon. In some embodiments, the additional oxidant for dual mode operation is dissolved Br₂, I₂, FeCl₃, K₃Fe(CN)₆, poly sulfides, etc. In some embodiments, the oxidant can be injected in pure or concentrated form over the cathode, or into a flow-through cathode.

In some embodiments, the oxidant recovery can be done externally and independently (e.g. the Br₂ “filling station” concept). In some embodiments, the recovered oxidant can be injected in pure or concentrated form over the cathode, or into a flow-through cathode. The recovered oxidant can be pre-mixed into the catholyte before flowing into cell. In other embodiments, the oxidant recovery can be done by sparging, evaporation, or any other suitable method.

In some embodiments, the liquid organic anolyte can be flowing and optionally purified and re-cycled into the system. The third “protection” stream of liquid electrolyte is flowed over the cathode side of the membrane to protect it from the aqueous catholyte and oxidant. In some embodiments, a separator is not utilized between catholyte and protective stream, in order to use a laminar flow method wherein the two liquids may be immiscible. In some embodiments, a dispersion blocker or a separator, e.g. polymer, can be placed between the protective stream and the catholyte. The catholyte can flow through a porous cathode, while protective stream flows through a non-conducting porous layer to control pressure driven crossover or a free stream, optionally with a dispersion blocker on top of the cathode. In some embodiments, the different anode can be solid metal or H₂ gas.

In addition to the embodiments described above, there are other embodiments of the technology as described herein. The following non-limiting embodiments related to the inventive technology include the following.

In order to meet the versatile power requirements of the autonomous underwater vehicles (AUV), a rechargeable lithium-bromine/seawater fuel cell can be fabricated with a protected lithium metal anode to provide high specific energy at either low-power mode with seawater (oxygen) or high-power mode with bromine catholytes. The proof-of-concept fuel cell with a flat catalyst-free graphite electrode can discharge at 3 mW/cm² with seawater, and 9 mW/cm² with dilute bromine catholytes. The fuel cell can also be recharged with LiBr catholytes efficiently to recover the lithium metal anode. Scanning electron microscopy images reveal that both the organic electrolyte and the bromine electrolyte corrode the solid electrolyte plate quickly, leading to nanoporous pathways that can percolate through the plate, thus limiting the cell performance and lifetime. With improved solid electrolytes or membraneless flow designs, the dual-mode lithium-bromine/oxygen system could enable not only AUV but also land-based electric vehicles, by providing a critical high-power mode to high-energy-density (but otherwise low-power) lithium-air batteries.

Autonomous underwater vehicles (AUV) have important potential applications in energy and environmental science, such as ocean monitoring for climate analysis, marine animal observation, undersea oil platform and pipeline inspection, and remote surveillance of submerged structures, bridges, ships, and harbours. Seawater-based fuel cells for AUV are attractive for long-time missions, but have low power, below the needs of communication and propulsion, while Li-ion batteries offer higher power for short times (<1 hour). This paper presents a rechargeable dual-mode lithium-oxygen/bromine fuel cell capable of running on seawater at low power with bromine injected on demand for higher power, analogous to nitrous oxide fuel injection in race cars with traditional internal combustion engines. Besides AUV, this dual-mode concept could also be an enabling technology for land-based electric vehicles, by providing high-power operation to lithium-air batteries, whose high energy densities are otherwise compromised by low power.

Fossil fuels are the dominant energy resources enabling rapid economic development around the world, especially in transportation. Increasing energy demand has encouraged not only the development of sustainable, renewable power sources for a better environment in the coming decades, but also the exploitation of deep-sea oil reservoirs all over the globe, including the Arctic Ocean. As already witnessed in the Gulf of Mexico oil spill in 2010, accidents and equipment failures in undersea fossil fuel extraction and transport can adversely affect the life and health of marine animals, humans and whole ecosystems. Given that the extreme environment around the undersea facilities does not permit frequent or long-time human access, autonomous underwater vehicles (AUV) have become powerful tools for remote inspections, e.g. tracking the oil plume. Besides petroleum engineering, AUVs also have many other important applications related to energy and the environment, such as hydrographic observation and seabed mapping for climate science and marine ecology, remote inspection of wrecks, bridge platforms, harbours and other undersea structures for safety and security.

A critical challenge for the development of AUV for these and other more versatile tasks in the future is to find a suitable power system. A wide range of electrochemical technologies has been suggested as power sources for AUV, such as Al/H₂O₂, NiCd, NiMH, and Li-ion batteries, as well as more advanced concepts, such as a semi-fuel cell using oxygen dissolved in seawater as the oxidant, and magnesium or lithium as the fuel. While these power sources have managed to fulfil specific tasks, the need for new power sources for marine applications still exists, because traditional battery systems, such as NiCd, NiMH and Li-ion, suffer from low energy density, while the metal-O₂ semi-fuel cell and other seawater batteries suffer from limited power density.

Adopting after the novel design of a hybrid-electrolyte Li-air battery, a dual-mode operation can be undertaken by modifying or changing the catholytes, which allows (i) a low-power mode by reducing oxygen dissolved in water to support enduring tasks, such as computer hibernation, lighting, video recording, etc.; and (ii) a high-power mode by reducing bromine catholytes to meet surge requirements, such as orientation adjustment, fast propelling, and acoustic signal communications. The bromine catholyte could be prepared via an online-mixing process, as demonstrated for an aluminium-based seawater battery, which injects hydrogen peroxide as the reaction booster to the seawater stream, or carrying a tank of optimal catholyte separately. Both modes of the proposed concept possess high specific energy, using relatively low-cost, commercially available materials.

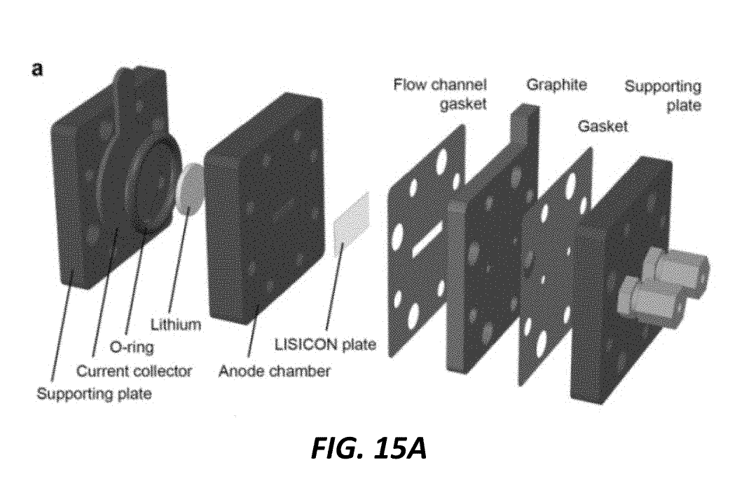

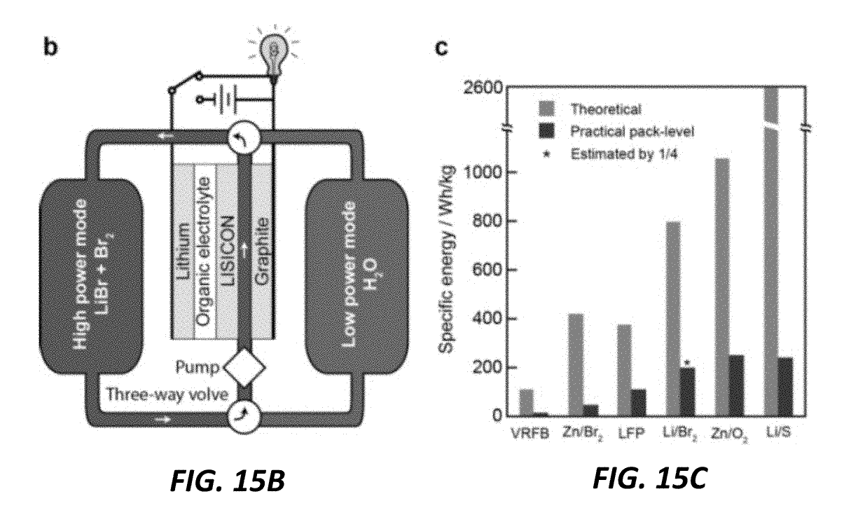

The cell design for the two modes of operation is shown schematically in FIGS. 15a and 15b, where the key component is the solid-electrolyte plate of lithium superionic conductor (LISICON). To avoid chemical reduction of Ti(IV) in LISICON, a buffer layer must be placed between lithium metal and LISICON. One effective choice is lithium phosphorous oxynitride (LiPON). West et al made a high-performance protected lithium metal anode by sputtering LiPON directly onto the LISICON plate, followed by thermally evaporating lithium onto the LiPON film to ensure intimate interfacial contact. However, the low ionic conductivity of LiPON limits its thickness to less than a few microns, which can result in the loss of intimate contact of the solid-solid interface during recharging cycles, and evaporating lithium metal requires a highly inert atmosphere. These practical and experimental issues can be avoided by using non-aqueous organic electrolyte as the buffer layer, thus forming a liquid-solid-liquid lithium-ion pathway between anode and cathode. This design was introduced by Zhang et al. in 2010 for a new type of lithium-air battery, but it was soon realized that flowing aqueous catholyte, instead of breathing air naturally, could achieve comparable performance even without using any catalyst.

Goodenough and Youngsik first investigated Fe(NO₃)₃ aqueous solution in a static liquid hybrid-electrolyte cell, but found that the cell has a short life since the catholyte attacks the Ti(IV) of the solid electrolyte. Lu and Goodenough then demonstrated a flow cell using 0.1M K₃Fe(CN)₆ solution as the catholyte, a layer of carbon paper or porous nickel as the diffusion layer and current collector. Through this pioneering work, Lu, Goodenough and Youngsik summarized the possible redox species for aqueous catholytes. In the same year, Wang et al. independently demonstrated the same concept in a static cell, using 0.1M FeCl₃ solution as the catholyte and a titanium mesh as the current collector. Zhao, Wang and Byon later extended the chart of redox couples suitable for aqueous cathodes by adding the data of solubility, since it is the mathematical product of the redox potential and the solubility of the species determines the specific energy (Wh/kg) and energy density (Wh/L) of the aqueous cathode. They then identified iodine as one promising candidate, and explored the possibility of I₂/I₃⁻ both in a static liquid cell and a flow cell. Along this line of research, Zhao et al. further investigated the feasibility of using dilute bromine catholyte in a static liquid cell. Different from the design of the above systems, Chang et al. paired a coated lithium metal anode, which has a hydrophobic polymeric layer between lithium metal and LISICON, with a tiny glassy carbon electrode in a more concentrated bromine catholyte to achieve much better performance. More recently, Takemoto and Yamada investigated the impedance of their static liquid cell, and correlated the increase of internal resistance to the chemical and structural degradation of LISICON. Their findings suggest that a Li⁺-depletion layer will develop into the surface of the LISICON, even after three days of soaking in bromine catholytes.

While it may be easier to fabricate a static liquid battery, the closed design prevents the cell from working at the maximum power density, since the corresponding voltages are always well below the voltage of hydrogen evolution. The internal pressure built up in the cathode chamber due to gas generation will eventually rapture the fragile LISICON plate and instantly suffocate the cell. These issues can be managed, and the power enhanced, in a flow system.

As described herein, the design and fabrication of a rechargeable lithium-bromine/oxygen fuel cell is demonstrated using the liquid-solid-liquid design of the hybrid electrolyte system and a catalyst-free graphite plate as the cathode and current collector. The performance of the cell with various catholytes containing dissolved oxygen is investigated and presented with polarization curves to demonstrate the feasibility of dual-mode operation at constant voltages, and the morphological changes of the aged LISICON plates are analyzed.

Developing seawater batteries and fuel cells has a long history. However, the use of metal anodes remained elusive until the development of the LISICON protection layer. This allows lithium metal to be paired with an aqueous electrolyte. The proposed design here uses oxidation of lithium metal at the anode according to the following equation,

Li→Li⁺+e⁻ (1)

which has the standard potential at −3.04V v.s. SHE, and possess a theoretical capacity of 3861 mAh/g.

For the cathode, the first desired reaction during discharge is the reduction of the dissolved oxygen in seawater,

O₂+4 e⁻+2 H₂O→4 OH⁻ (2)

which has a standard potential that depends on the pH of the catholyte and is given as the relation U^{o}=1.23-0.059×pH. It must be noted that the solubility of oxygen in seawater is typically smaller than 1mM. The desired four electron reduction of oxygen typically requires a precious metal catalyst and suffers from large kinetic overpotentials. Hence, this mode can only generate moderate current densities and forms the low-power mode of the cell. The overall discharge product of reactions (1) and (2) is LiOH, which has a solubility of 5.3 M at 25° C.

One of the important competing reactions at the cathode is the hydrogen evolution reaction, given by

2 H₂O+2 e⁻→H₂+2 OH⁻ (3)

which also has a standard reduction potential that is pH dependent, according to the relation U^{o}=−0.059×pH. For the lithium-bromine static liquid battery, Zhao et al. suggested 3V as the safety limit to avoid H₂ evolution. As they also set the upper limit of voltage to 4.35V to avoid oxygen evolution, pressure fluctuations in the cathode chamber of the static liquid cell could easily rapture the LISICON plate, after which lithium metal will quickly react with water chemically, and fail to supply electricity any more. Therefore, the cut-off voltages are rather the failure limits of the static liquid cell. This inevitable difficulty led to the open/flow system, which can better tolerate the pressure fluctuations and bring the gases out of the cathode chamber/channel along with the stream.

To achieve a higher power output, an extra oxidant that can operate in a similar voltage range as the low power mode and compatible with an aqueous electrolyte is necessary. Bromine has been demonstrated in many flow battery systems, and the reaction has very fast kinetics without the need for any precious metal based catalyst,

Br₂+2 e⁻→2 Br⁻ (4)

which has a standard potential of 1.09V v.s. SHE. The final discharge product in the high power mode is LiBr, which has extraordinary solubility of about 18.4 mol per kg of water at 25° C. The theoretical specific energy based on the solubility limit of LiBr is 791.5 Wh/kg, whose practical pack-level specific energy, estimated as ¼ of the theoretical value, could make ˜200Wh/kg, superior to many existing systems, e.g., LiFePO₄, as can be seen in the comparison chart of FIG. 15c.

The pH of catholytes is important. For the low power mode, changes of the pH will lead to the variation of the voltage. For the high power mode, while bromine reduction is the dominant reaction under acidic conditions, several other competing electrochemical processes are also possible under neutral and alkaline conditions. More importantly, the stability of the LISICON plate is also pH dependent and has enhanced stability in neural to moderately basic environment. Balancing these factors, we utilize a neutral pH environment for the catholyte striking compromise between kinetics of cathode reactions and the stability of the LISICON membrane. This design choice is also compatible with the pH of seawater, which is mildly alkaline with pH in the range of 7.5 to 8.4. At neutral pH, the OCV of the low power mode is 3.86 V and the OCV of the high power mode is 4.13 V.

In light of all the design considerations discussed above, a scheme of dual-mode discharge can be proposed to reduce either the species in seawater as the low-power mode, or the bromine and lithium bromide solution as the high-power mode. The system uses the high-power-mode catholyte for recharging. Proof-of-concept cells were fabricated and tested following the steps described in the Methods section.

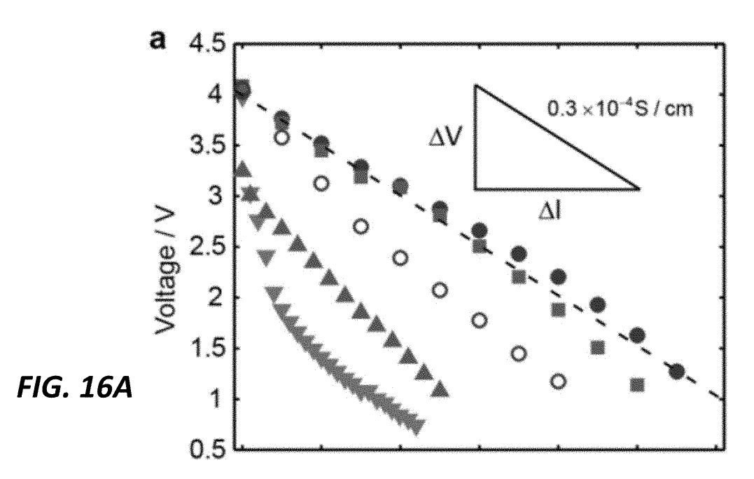

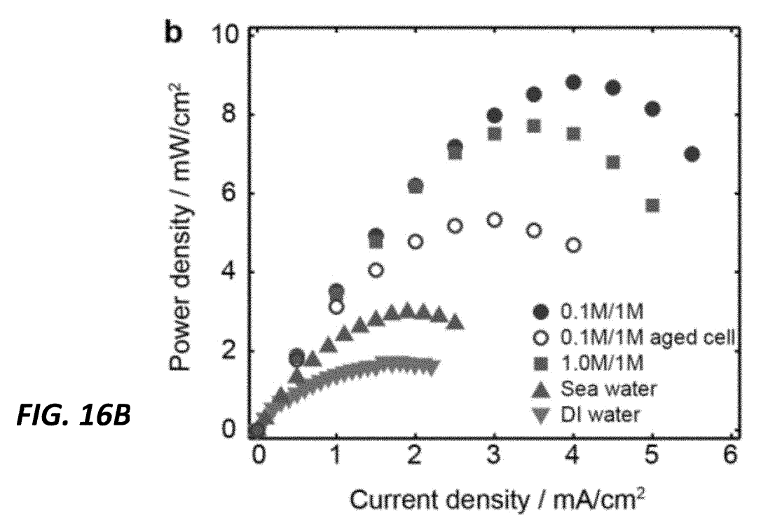

The results of the electrochemical performance for various catholytes are as follows. As shown in FIG. 16a, the voltage of the cell varies linearly with respect to the current density, and the slope yields the conductivity in the same order of magnitude of the solid electrolyte, which is the main source of internal resistance and power limitation.

When deionized (DI) water is used as the catholyte, the cell works as a hybrid-electrolyte aqueous Li-air battery, but exhibits large activation polarization since no catalyst is incorporated into the graphite cathode. The cell provides a peak power around 1.8 mW/cm² at 1V. When natural seawater collected from Boston harbour is used, the power density increases to 3 mW/cm² at a higher voltage around 1.5V, likely due to a higher concentration of dissolved oxygen.

In contrast, the performance is significantly improved with a dilute catholyte of Br₂ and LiBr solution, providing a peak power around 9 mW/cm² at 2.2V, which is consistent with the recent report of static Li-Br liquid battery. The fact that increasing the concentration of Br₂ does not improve the discharge performance reveals that the rate-limiting process is not the transport in the catholyte, but the conduction of lithium ions through the solid electrolyte. The deviation of high-concentration performance from the low-concentration performance at current densities larger than 3 mA/cm² is due to the degradation of LISICON. Such degradation becomes more significant after weeks of various experiments, and the slope of the polarization curve of the aged cell becomes much steeper that the fresh cell as shown in FIGS. 16a and 16b.

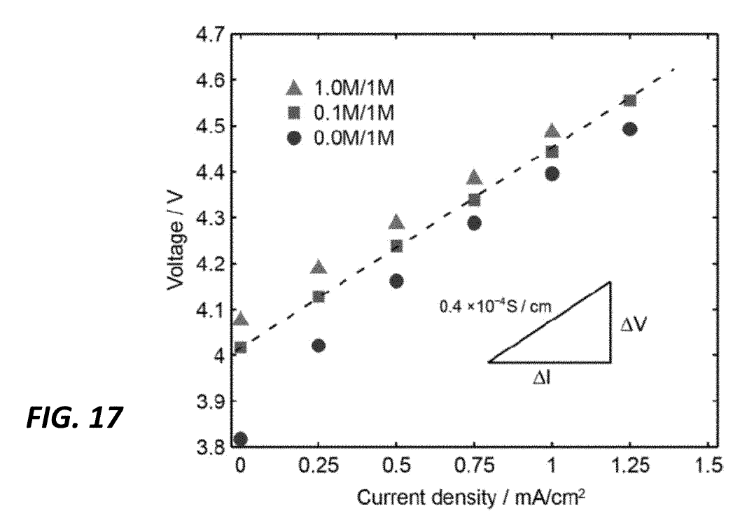

Although re-charging the cell with both DI water and seawater can help, neither of them can sustain a current as small as 0.025 mA/cm² at voltages up to 5V, which is to be expected given the lack of any added catalyst in the system. FIG. 17 shows the polarization curves for charging processes with various bromine and lithium bromide catholytes. The conductivity estimated from the slope is consistent with that of discharge, again indicating the rate-limiting resistance of the LISICON layer. During recharging, increasing the concentration of Br₂ in the 1M LiBr solution results in clear increases of voltages, which can be viewed as a state-of-charge (SOC) dependent voltage behavior that can be explained by Nernst equation. However for the open system as described herein, more importantly, a low concentration of Br₂ in LiBr catholyte can be maintained, so as to ensure a current as high as possible for fast recovery of the lithium metal anode.

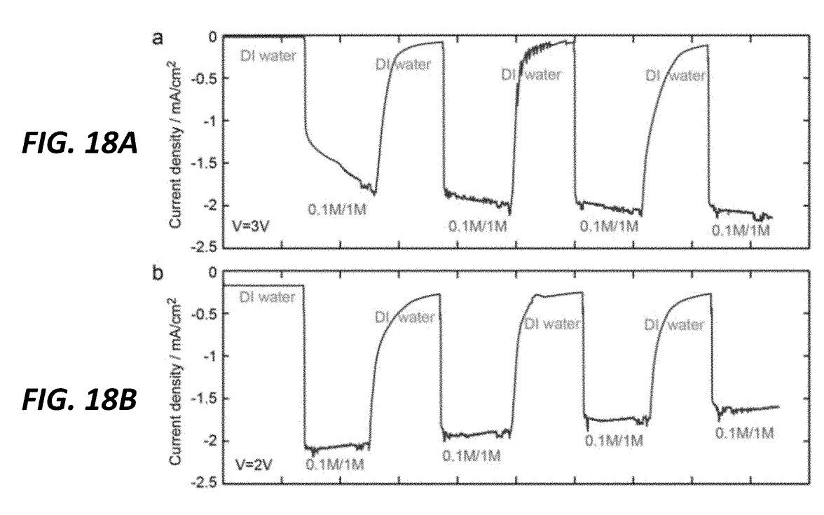

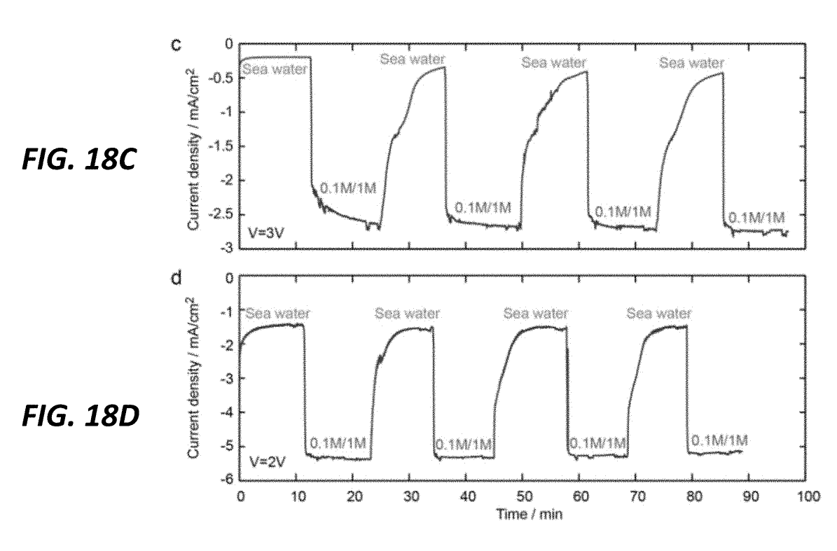

In order to operate in a dual-mode operation at constant voltages, the following has to undertake. The dichotomy in power output during dual-mode operation is best demonstrated by holding the cell at constant voltage and periodically switching the working catholytes. In order to reduce the mixing of two catholytes, a small segment of air is allowed into the tubing, and a higher flow rate, 3 ml/(min⋅cm²), is used. The experimental results are shown in FIGS. 18a-18c. The values of the currents at 3V and 2V for different catholytes are consistent with those reported in FIGS. 16a and 16b, except that in FIG. 18b, the current of 0.1M/1M catholyte under 2V is much smaller, which is due to the degradation of LISICON as seen below.

The polarization curve of one of the aged cells is included in FIGS. 16a and 16b indicated by the open circles, which reveals the decaying conductivity of the system. Takemoto and Yamada suggested that the deterioration of the cell performance mainly comes from the degradation of LISICON, and more specifically the formation of a Li-ion depletion layer penetrating the surface of the LISICON. Here, to verify the source of degradation of the cell used in FIG. 18b, the cathode part of cell was first dissembled. Neither leakage of organic electrolyte, nor visible cracks were found on the LISICON plate, but some light brown stains can be seen in the region of the flow channel. The stains were carefully removed with wet paper tissues, and the surface of the LISICON plate was thoroughly washed with DI water. The graphite cathode was rigorously polished with sand paper for fresh surfaces and thoroughly washed with DI water as well. The re-assembled cell, however, did not recover the performance of a fresh cell, but became even worse. Opening the anode part afterwards, many pieces of organic electrolyte and a shiny lithium metal chip can be found. These observations confirm that the degradation mainly comes from the LISICON plate, as Takemoto and Yamada also concluded, even though the LISICON plate is believed to be stable in seawater for up to two years.

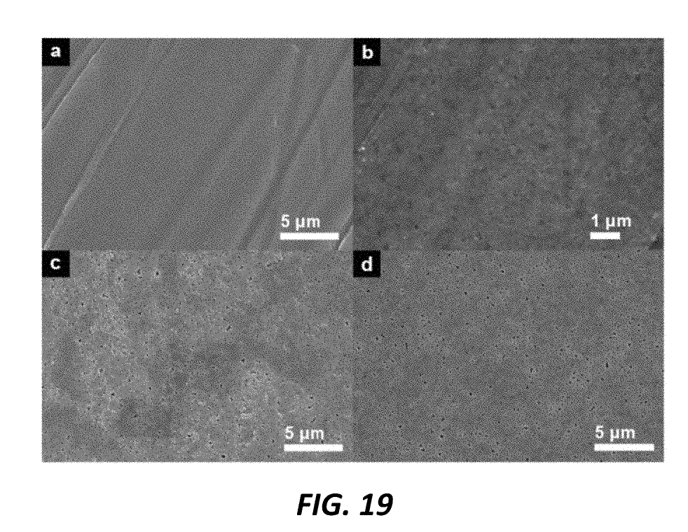

The corrosion of LISICON plate can be a cause for concern. FIGS. 19a-d compare the morphological changes on the surfaces of the fresh and aged LISICON plates. The aged LISICON plate was in service for 2 weeks, contacting static organic electrolyte and flowing aqueous catholytes on either side. After being detached from the cell, the debris were collected into a small vial with DI water and applied sonication for 30 seconds, and then thoroughly washed with DI water without using sonication for four times. The samples were transferred to small petri dishes, dried at 50° C. for 30 minutes, and kept in atmosphere before the scanning electron microscopy (SEM) observation. For the purpose of easier focusing, the new LISICON plate was lightly polished with a fine sand paper. While in a lower magnification, the surface of the plate looks smooth (FIG. 19a), very shallow cavities can still be seen in a higher magnification (FIG. 19b). In contrast, deep cavities can be easily identified on both surfaces of the aged LISICON plate. The surface in contact with aqueous bromine catholyte becomes very rough; flows of the catholytes flushed out shallow valleys on the surface (FIG. 19c). The surface in contact with static organic electrolyte looks perfectly flat, but surprisingly the density of the deep cavities is evidently higher than the other surface.

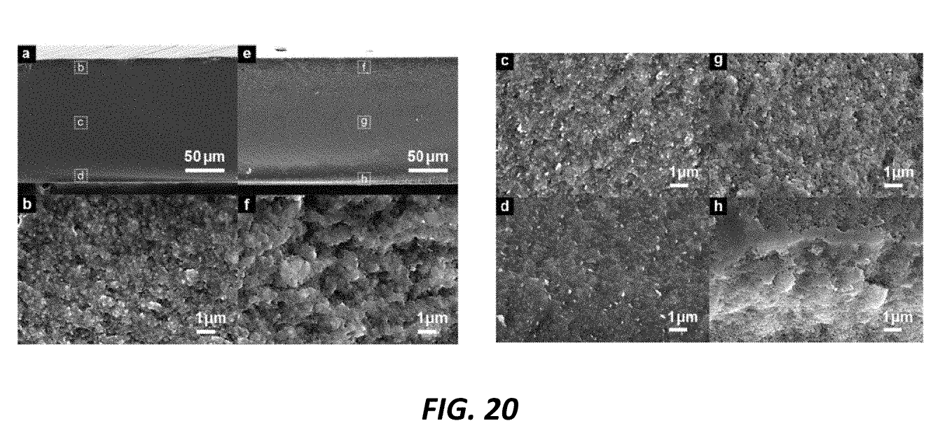

FIGS. 20a-h provide SEM images of the cross sections of the same plates shown in FIGS. 19a-d. While the new plate looks dense and uniform throughout its whole thickness with very few nanopores, both surfaces of aged plate become rather porous, and nanopores can be observed everywhere in its cross section. These microscopic observations help explain the fact that it is very difficult to make scratches on the surface of the fresh LISICON plate with a single-edge blade, but much easier on the aged one.

Analogous to the Nitrous Oxide System used in race cars, which injects N₂O to provide extra oxygen to increase the power output of the internal combustion engine, the dual-mode lithium-bromine/oxygen fuel cell allows the injection of bromine as the reaction booster to provide higher power density on demand. In practical applications to AUV, the low power mode with seawater can be used for computer hibernation, lighting, powering sensors and on-board equipment, while the high-power mode could significantly increase the propelling speed, or enable other high-power functions, such as acoustic signal transmission. In both cases, the high energy density provided by lithium metal allows extended working time undersea and opens up the possibilities of more versatile tasks.

This dual-mode design also holds promise for land-based electric vehicle applications. The catalyst-free high-power mode could be a good substitute of current Li-air batteries, which suffer from low power, low efficiency, low cycle life, and poor chemical stability, while preserving a similar high energy density. One way to realize this could involve circulating a small amount of water and mixing pure bromine into the stream to maintain the optimal concentration for desired power output. If designed in the lithium-abundant format, recharging the fuel cell requires simply refuelling the liquid bromine. In some extreme cases that bromine is no longer available on board nor nearby, the fuel cell can still provide electricity at a lower power, i.e. working as a modest lithium-air battery. When it is time to recover the lithium metal anode, highly concentrated LiBr solution can be used to enable fast electrochemical recharging of the fuel cell.

The relatively low conductivity of the solid electrolyte plate limits the power output of the cell. However, as has been seen in the experiments, the estimated conductivities indicate extra Ohmic losses in the system. Besides reducing the thickness of both liquid layers, it is also important to optimize the cathode. Recent experiments have shown that the power density can be improved with a glassy carbon electrode or a porous carbon electrode made of acetylene black and PVDF. Wang et al developed a carbon electrode by uniformly fixing 2-5 nm LiBr particles on to the nanoporous structure of the conductive carbon black substrate. While they only demonstrated the application of this novel electrode in a traditional lithium-ion battery, this electrode also holds promise for high power flow systems.

On the other hand, the chemical and mechanical robustness of the LISICON plate determines the life of the cell. While it is reported that the solid electrolyte remains stable in seawater for two years, corrosion of the solid-electrolyte plate is not negligible. For one of the oldest cells, organic electrolyte could come out through the mechanically intact LISICON plate when the internal pressure of the anode chamber is increased, either by tightening the anode chamber (compressing the silicone O-ring) or injecting more electrolyte. Water could percolate through the solid electrolyte and attack the lithium metal anode, well before the macroscopic disintegration of the solid electrolyte plate. The situation could be worse under the high pressure resulted from deep-sea environment. It is also worth noting that the 150-μm-thick LISICON plate is quite fragile, microcracks could be developed due to the imbalanced forces during assembling. Before a flexible water-stable solid electrolyte is developed, a hydrophobic polymer lining between LISICON and lithium metal seems to be a viable approach to compensate the mechanical vulnerability of the LISICON plate and block water molecules coming through the cracks and porous networks.

Compared with cathode materials, water-stable solid electrolytes have received much less research attention. But as exemplified by this work and recent sodium-seawater fuel cells, solid-electrolyte-enabled rechargeable fuel cell could be a promising technology to harvest and utilize the clean “blue energy” in the ocean. Given that sodium is abundantly available in seawater, a dual-mode sodium-bromine/seawater fuel cell or flow battery could be an economical substitute to the proposed system. Developing better solid electrolytes is apparently the key to commercialize these technologies, but it may also become feasible to develop a membraneless system using immiscible electrolytes to replace the LISICON plate, which could increase the power output, extend the life of the cell and dramatically lower the cost of the system.

The design and fabrication of a proof-of-concept rechargeable lithium-bromine/oxygen fuel cell has been successfully demonstrated that uses a solid-state LISICON plate to separate non-aqueous electrolyte and aqueous bromine catholyte. This design enables a dual-mode operation by changing the catholyte to deionized water or seawater, which could be applied to autonomous underwater vehicles for both long-time endurance operation and high-power activities. While the static liquid cell can only work between voltages of oxygen evolution and hydrogen evolution to avoid fractures of the LISICON plate due to the imbalance of the pressure, the flow system can better tolerate the gas evolution and thus can work in more extreme voltages to provide higher power density. It can be shown that organic electrolyte has a strong corrosive effect on the LISICON plate, which must be addressed before a long-lasting lithium-bromine rechargeable fuel cell can be developed, building on the concept.

In some embodiments, the cell fabrication is as follows. All components of the fuel cell were fabricated using traditional CNC machining or die cutting. As depicted in FIG. 15a, the cell was housed between two pieces of polyvinylidene fluoride (PVDF) porting plates. A piece of copper plate was used as the current collector, and a piece of lithium metal chip as anode. To accommodate the organic electrolyte between the lithium metal and the LISICON plate, a rectangular through hole was machined in a third PVDF plate, which also serves as the supporting plate to anchor four bolts for assembling components of either side of the LISICON plate. A small piece of LISICON plate was cut off by a diamond scriber, and bound to one side of the supporting PVDF plate by a thin layer of epoxy, and cured for at least 24 hours. The anode part was then assembled accordingly in an Ar-filled glove box, and sealed by a silicone O-ring between the copper current collector and the supporting PVDF plate. The organic electrolyte was injected into the anode chamber by a syringe as the last step. The cathode part was assembled in ambient environment. The flow channel of the catholyte was defined by a compressible Teflon gasket, whose thickness reduces to 300 μm after final assembly. A 6-mm-thick graphite plate was machined accordingly as the cathode, whose surface was simply polished with a sand paper. Another piece of gasket was placed between the graphite and the porting plate. The areas of the cross sections of the anode chamber and the flow channel are approximately the same 0.64 cm².

For materials, all chemicals were used as received. Bromine (ACS Reagent, >99.5%), lithium bromide (ACS Reagent, >99.5%) and the organic electrolyte (1 M LiPF₆ in ethylene carbonate/dimethyl carbonate with a volume ratio of 1:1) were purchased from Sigma-Aldrich. The solid electrolyte plate (AG-01, Li₂O-Al₂O₃-SiO₂-P₂O₅-TiO₂-GeO₂, 10⁻⁴ S/cm, 25.4 mm square by 150 um) was purchased from Ohara Inc, Japan. Copper foil (3 mm thick, 99.5%), polyvinylidene fluoride (PVDF) plates, graphite plates, silicone o-rings and Teflon gasket tape (Gore) were all purchased from McMaster-Carr. PTFE tubing and fittings and peristaltic pumps were purchased from Cole-Parmer. Ultrapure deionized water was obtained from a water purification system (Model No. 50129872, Thermo Scientific). Seawater was collected in the Boston Old Harbour in Massachusetts and filtered with two layers of filter paper before experiments.

For electrochemical measurements, all electrochemical tests were conducted with an Arbin battery tester (BT-2043, Arbin Instruments) and cells were kept in a fume hood at room temperature. To obtain the polarization curve, a peristaltic pump and PTFE tubing were used to drive the catholyte flow at the rate of 1 ml/(min cm²) until the open-circuit voltage reached a stable value. Then the cell was discharged or charged at certain currents for five minutes, whose response voltages usually stabilized in 1 minutes, but the reported values in this work are averaged voltages over the five minutes. The cell was flushed at 5 ml/(min cm²) with DI water for 30 mins and air for 10 mins before introducing a different catholyte.

In some embodiments, a lithium-bromine battery (or fuel cell) can be designed where, in one embodiment, seawater as is used as the electrolyte in a power source for autonomous underwater vehicles. This battery would have two modes of operation, low power mode and high power mode. Under the low power mode, the battery would utilize the chemistry of oxidation of lithium at the anode and the reduction of dissolved oxygen and seawater as the cathode reaction, giving a specific energy of LiOH is 428.5 Whr/kg and energy density of 471.4 Whr/L. Under the high power mode, the battery would utilize the chemistry of oxidation of lithium at the anode and the reduction of bromine at the cathode, yielding a specific energy of 791.5 Whr/kg and energy density of 1357 Whr/L. This novel design yields a high energy density (Wh/kg), a key metric for underwater applications. In other embodiments, with different electrolytes, the Li/Br system could also be applied to land-based transportation.

With the aid of advanced sensor and sonar capabilities, naval applications are requiring high power sources. Some of the naval applications requiring compact energy-dense power include submarines, missile systems, mines, torpedos, countermeasure autonomous underwater vehicles (AUV), sonobuoys. One of the critical aspects that determine the duration and use cases of the naval missions is its power source. A wide range of electrochemical technologies has been suggested as a power source for naval applications. These include alkaline Al/H₂O₂, NiCd, NiMH, Li-ion batteries and more advanced concepts like a semi-fuel cell using oxygen dissolved in seawater as oxidant, seawater as electrolyte and magnesium as fuel.

However, the traditional battery systems such NiCd, NiMH and Li-ion suffer from a low energy density while the semi-fuel cell with Mg/dissolved oxygen suffers from a limited power density. The near-term requirement for the naval applications requires much higher power density than that provided by the seawater electrolyte battery technology. However, endurance explorations such as mine counter measures do benefit from the high energy density provided by the sea-water battery technology which allows a larger area coverage and turnaround time.

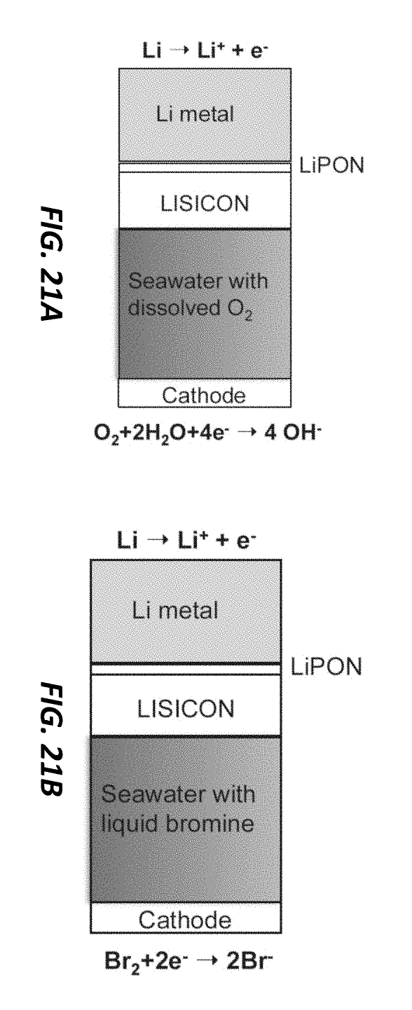

The two modes of operation are (a) low-power mode designed for endurance and (b) a high-power mode designed for surge requirements. Both of these modes of operation possess high specific energy (Whr/L) and energy density (Whr/kg). The battery cell design for the two modes of operation is shown schematically in FIGS. 21a and 21b with the overall electrochemical reactions at the anode and the cathode given.

Both the low power mode and high power mode utilize lithium metal at the anode. The electrolyte to be used in both cases is seawater. In order to make lithium metal compatible for use with seawater, a protection layer can be used; the protection layer can include a LiPON interlayer and a LISICON separator. This protection layer enables movement of Li⁺ ions while blocking electrons and other reactants such as O₂. The overall reaction at the anode is given by

Li→Li⁺+e⁻ (5)

In a low power mode of this design, the dissolved oxygen in seawater can be used as the oxidant at the cathode. The dissolved oxygen is a strong function of salinity, local temperature with solubility typically ranging from 0.3-1 mM. The overall desired reaction at the cathode must be

O₂+2H₂O+4e⁻→4OH⁻ (6)

The overall cell voltage with this reaction is 3.79 V. In order to derive the maximum possible energy density, it is crucial to also reduce water through the reaction

2H₂O+2e⁻→H₂+2OH⁻ (7)

The cell voltage from this reaction at the seawater pH of 8.2 is 2.56 V. The chosen cathode catalyst must be capable of catalyzing this reaction and also avoid chloride poisoning and other degradation reactions. Suitable candidate catalyst materials can be chosen for the pH range of operation. In the first iteration, Pt can be used as the cathode catalyst. LiOH has high solubility in water of nearly 5.3 M at 25° C. The specific energy based on solubility level of LiOH is 428.5 Whr/kg.

In a high power mode of this design, liquid bromine can be flown in hydrobromic acid along with seawater as the oxidant at the cathode. The overall desired reaction at the cathode must be

Br₂+2e⁻→2Br⁻ (8)

In the high power mode of this design, liquid bromine can also be flown in lithium bromide along with seawater as the oxidant at the cathode.

Br₂+2e⁻→2Br⁻ (9)

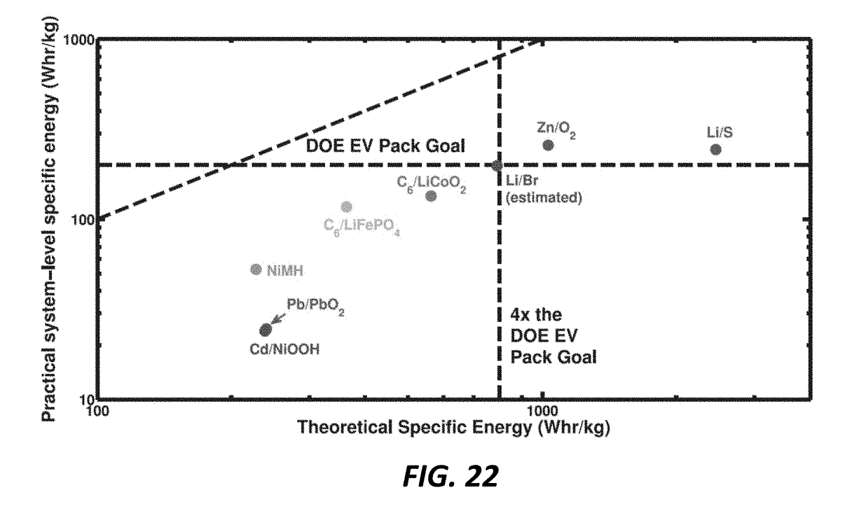

The cell voltage based on this chemistry is 4.17 V. This reaction has fast kinetics and does not require any precious metal based catalyst. LiBr has extraordinary solubility of about 18.4 M. The specific energy based on the solubility level of LiBr is 791.5 Whr/kg and an energy density of 1357 Whr/L. This is one of highest specific energy couples as shown in FIG. 22 and a realistic expected system level specific energy is estimated at ¼^{th} the theoretical specific energy. As described, the practical system-level specific energy of several battery couples and their theoretical specific energy based on the weight of active materials alone. The DOE pack goal for an EV with a 40 kWh battery pack is shown, as well as the approximate theoretical energy, set at 4 times the DOE pack goal, required for a couple to have a chance of meeting the pack goal. There is at present no system-level specific energy for a Li/Br battery and the number used is a realistic estimate. The data for all the other battery couples in the figure is taken C. Wadia et al. from the J. Power Sources, 196, 1593 (2011).

The dual-mode operation proposed here has limited prior precedent. A dual-mode operation has been proposed based on an aluminum-based seawater battery for marine applications. The low power mode was operated based on aluminum-seawater chemistry and the high power mode was operated by on-line mixing of hydrogen peroxide with the seawater electrolyte. They have been able to demonstrate low/high power switching with this chemistry. The successful demonstration of the dual-mode system lends additional confidence into the viability of the system proposed here. The system proposed here possesses much higher power density and specific energy than the Al-seawater system.

This cell can also be run without a membrane. This will be accomplished by flowing a compatible and wetting liquid electrolyte over the Li metal, a combination of organic ethylene carbonate/dimethyl carbonate with a lithium salt, LiPF₆. This need not be immiscible, as we will exploit flow to keep everything separate until it leaves the cell. This is a highly novel scheme for a fuel cell, and it may allow us to reach very high power densities suitable for submarines, if the ohmic losses can be managed.

Given the high energy density with the promise to meet DOE targets for electric vehicles, aqueous Li-Br battery could also have applications for transportation on land, replacing the seawater electrolyte with hydrobromic acid or lithium bromide in water. The reactions would remain the same as that described in the high power mode.

In some embodiments, a fuel cell or flow battery can include a metal anode, a solid or liquid anolyte, a liquid catholyte, a liquid redox cathode and a current collector. For dual mode applications, an additional oxidant can be injected into the catholyte and passed over the cathode to boost discharge power. The metal anode can be one of Li, Mg, Na, and Al. In some embodiments, the anolyte is a water-stable zero-porosity metal ion conducting solid electrolyte membrane, LIPON, LISICON, LATP, NaSICON, or the like. The anolyte can be a pure or mixed aprotic solvents, such as EC, PC, DEC, DMC, DME, DOL, etc., with metal salt separated from catholyte by a solid electrolyte membrane (LATP manufactured by Ohara). The anolyte can also include room temperature ionic liquids or RTIL/solvent mixtures, as described in “A new class of solvent-in-salt electrolyte for high-energy rechargeable metallic lithium batteries,” Nature communications, 4, 1481 by Suo, Hu, Li, Armand, and Chen.

In some embodiments, the catholyte can be an aqueous containing O₂, Br₂, I₂, FeCl₃, K₃Fe(CN)₆, poly sulfides, etc. In some embodiments, the cathode can “flow over” graphite. In some embodiments, the cathode can “flow through” a porous carbon. In some embodiments, the additional oxidant for dual mode operation is dissolved Br₂, I₂, FeCl₃, K₃Fe(CN)₆, poly sulfides, etc. In some embodiments, the oxidant can be injected in pure or concentrated form over the cathode, or into a flow-through cathode.

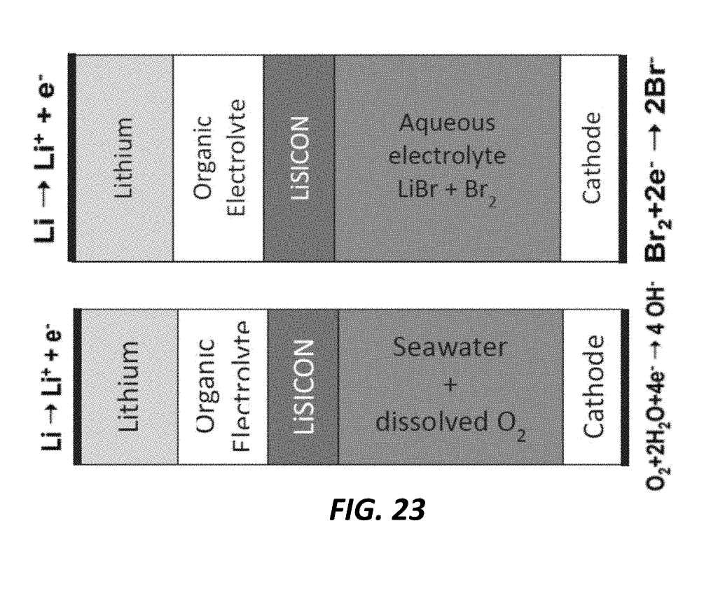

FIG. 23 shows schematics of the cell design in FIG. 21 with organic electrolyte. The cell includes lithium metal, organic electrolyte, and LISICON separator.

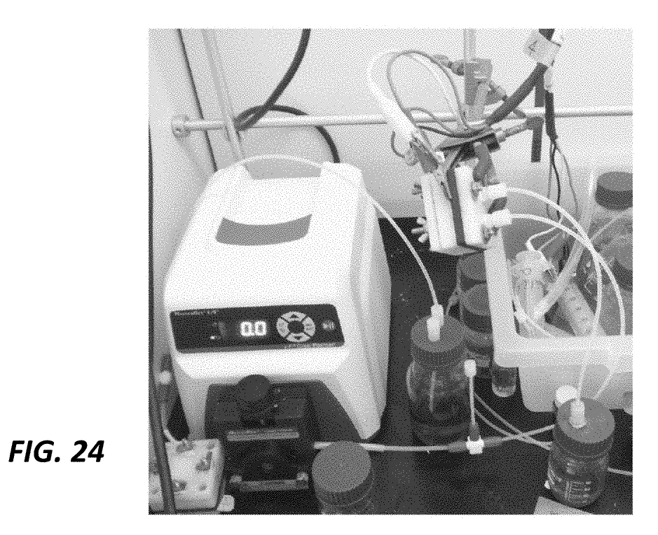

FIG. 24 shows a picture of an exemplary experimental setup.

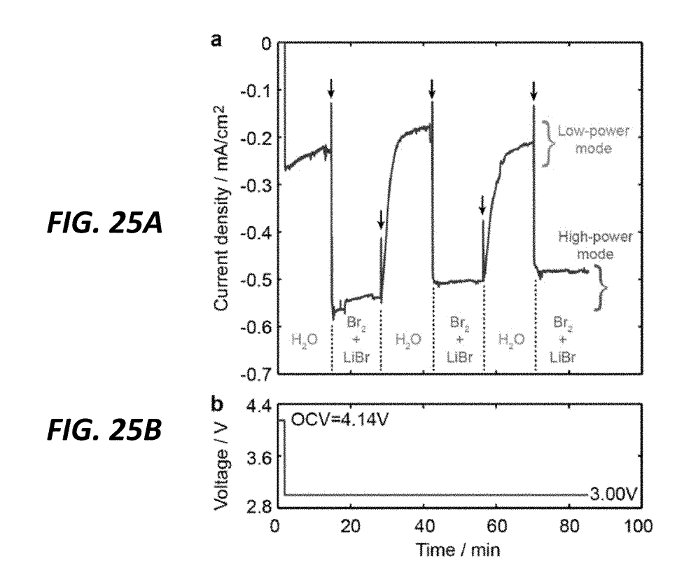

FIG. 25a shows a dual mode operation at low power mode and high power mode represented by a plot of current density versus time and FIG. 25b shows the plot of the open circuit voltage as a function of time.

There are six major ions make up >99% of the total ions dissolved in seawater. They are sodium ion (Na⁺), chloride ion (Cl⁻), sulfate ion (SO₄²⁻), magnesium ion (Mg²⁺), calcium ion (Ca²⁺), and potassium ion (K⁺). Accordingly, NaSICON enabled hybrid-electrolyte flow battery can be fabricated. For discharge, the reactions are as follows:

Na→Na⁺+e⁻ (10)

4 e⁻+O₂+2 H₂O→4 OH⁻ (11)

For charging, the reactions are as follows:

Na⁺+e⁻→Na (12)

2 Cl⁻→Cl₂+2 e⁻ (13)

For high-power mode, Br₂/NaBr catholyte can be used.

We claim:

1. An electrochemical cell comprising:
an anode comprising Li metal;
a non-aqueous electrolyte in conductive contact with the anode;
a lithium conductive, water-impermeable solid electrolyte in conductive contact with the non-aqueous electrolyte;
a catholyte comprising an aqueous solution of Br₂ and/or O₂ in conductive contact with the solid electrolyte; and
a current collector in conductive contact with the catholyte;
wherein during discharge, anions can diffuse from the catholyte to the anode, and cations can diffuse from anode to the catholyte.

2. The electrochemical cell of claim 1, wherein during discharge, Br₂ is reduced and Li is oxidized.

3. The electrochemical cell of claim 1, wherein during discharge, O₂ is reduced and Li is oxidized.

4. The electrochemical cell of claim 1, wherein the said electrochemical cell of claim 1 is reversible, whereby during charging the Br⁻ produced during discharge is oxidized to Br₂.

5. The electrochemical cell of claim 1, further comprising means for storing and means for introducing Br₂ into the catholyte.

6. The electrochemical cell of claim 1, wherein the anode is in contact with the non-aqueous electrolyte, the current collector is in contact with the catholyte, and the solid electrolyte is disposed between, and in contact with, the non-aqueous electrolyte and catholyte.

7. An electric vehicle comprising electric propulsion means powered by at least one electrochemical cell of claim 1.
